(19) United States
(12) Patent Application Publication
(10) Pub. No.: US 2016/0137806 A1
(43) Pub. Date: May 19, 2016

(54) SOLID-STATE THERMOPLASTIC NANOFOAMS

(71) Applicant: UNIVERSITY OF WASHINGTON THROUGH ITS CENTER FOR COMMERCIALIZATION, Seattle, WA (US)

(72) Inventors: Vipin Kumar, Seattle, WA (US); Huimin Guo, Seattle, WA (US)

(73) Assignee: UNIVERSITY OF WASHINGTON THROUGH ITS CENTER FOR COMMERCIALIZATION, Seattle, WA (US)

(21) Appl. No.: 14/900,903

(22) PCT Filed: Jun. 27, 2014
(86) PCT No.: PCT/US14/44687

§ 371 Date: Dec. 22, 2015

Related U.S. Application Data
(60) Provisional application No. 61/840,598, filed on Jun. 28, 2013.

(51) Int. Cl. C08J 9/28

(52) U.S. Cl. CPC C08J 9/28; C08J 2369/00; C08J 2333/12; C08J 2381/06; C08J 2345/00; C08J 2367/02

(57) ABSTRACT

Disclosed is a solid state foaming method for the creation of nanofoams (about or less than 100 nm) by saturating thermoplastic polymers with liquid carbon dioxide, optionally, at low saturation temperatures of below room temperature and lower.

### BACKGROUND

Nanofoams, or nanocellular foams, refer to thermoplastic foams with cells generally on the order of 100 nm or less. Nanofoams can be regarded as an extension of microcellular foams with cells on the order of 10 μm that were conceived at Massachusetts Institute of Technology three decades ago.

In an early paper, a two-step process is described to create a microcellular structure in high impact polystyrene (HIPS). That process involved saturating the polymer with a non-reacting gas and then heating the gas laden polymer to near the glass transition temperature. This process later became known as the solid-state process, as the polymer foam is created near the T_{g} of the gas-polymer system, well below the melting point. This process has been used to investigate a number of polymers, including polyvinyl chloride (PVC), acrylonitrile butadiene styrene (ABS), polycarbonate (PC), and polylactic acid (PLA), to name a few. In a variation of this process, microcellular foams have been created by a sudden drop in gas pressure that causes a solubility drop resulting in cell nucleation.

It has been widely hypothesized that nanofoams would offer many properties that are superior to existing unfoamed materials. Nanofoams can present a unique combination of properties not seen before, thus creating a new generation of cellular polymer materials. Recently, it was shown that nanocellular polyetherimide (PEI) had greatly improved mechanical properties when compared to microcellular PEI foams. It has also been reported that PEI nanofoams had higher flexural modulus and strength than the unfoamed material. Nanofoams have been hypothesized to have much lower thermal conductivity than microcellular foams due to reduced gas phase heat conduction, when cell size is close to the mean free path of air molecules at ambient temperature and pressure (about 70). This is called the Knudsen effect and has been demonstrated in organic aerogels and very recently in polymer nanofoams with cell sizes down to 100 nm. Another popular hypothesis suggests that nanofoams based on clear amorphous polymers, such as polymethyl methacrylate (PMMA) and PC, could present transparency when cell size is significantly smaller than the light wavelength. Such materials can be potentially used to create thermally insulative yet transparent windows, which can lead to huge energy savings for buildings. In addition, if pores could be created that are open and interconnected in the nanofoams, then a permeable nanoporous material can be produced. Nanoporous materials have been widely used in filtration, gas separation, energy storage, and catalysis supports.

Although the idea of creating nanofoams is exciting, the methods of making nanofoams have been very limited, and only a few polymers with uniform nanocells have been discovered. Polyimide nanofoams have been produced from block copolymers consisting of thermally stable and thermally labile blocks, where the thermally labile blocks underwent thermolysis upon thermal treatment, leaving nanopores behind. The solid-state gas foaming process has shown a great utility in creating polymeric nanofoams in polymer blends, such as polyether ether ketone (PEEK)/PEI blends, polypropylene (PP)/rubber blends and PMMA/methacrylamide (MAM) blends. The concept for these polymer blend nanofoams was essentially the same: one phase acted as the matrix and the other dispersed phase served as a template for bubble nucleation and growth. Nanofoams were created in PMMA and acrylic copolymers by adding a small amount of nanoparticles which served as nucleation sites and greatly enhanced cell nucleation. So far, in homopolymers, nanofoams have only been achieved in high glass transition temperature polymers—PEI and polyether sulfone (PES).

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In a conventional solid state process for making microcellular foams, polymers are initially saturated with a gas blowing agent (e.g., carbon dioxide) at room temperature or at elevated temperatures. Then, after full or partial saturation, the polymer is removed from the pressure vessel and heated to above the glass transition temperature of the polymer-gas system using a hot oil bath, hot gas, radiation, ultrasound, hot plate, or the like.

This disclosure relates to modifying the solid-state foaming process by using low temperature liquid carbon dioxide to make nanofoams (cells about or less than 100 nm). The method for making nanofoams includes steps for placing a thermoplastic polymer in a pressurized vessel that is maintained at a low temperature and filled with liquid carbon dioxide. The thermoplastic polymer is exposed to the liquid at the selected temperature and pressure for a time sufficient to saturate the thermoplastic polymer with the liquid. Then, the saturated thermoplastic polymer is exposed to a temperature above the glass transition temperature of the saturated thermoplastic polymer to provide a nanocellular foam.

Disclosed is a solid state foaming method for the creation of nanofoams (about or less than 100 nm) by saturating thermoplastic polymers with liquid carbon dioxide, optionally, at low saturation temperatures of below room temperature and lower.

Any method of making a thermoplastic polymer foam may include saturating a noncellular thermoplastic polymer with liquid carbon dioxide to produce a carbon dioxide saturated thermoplastic polymer; and heating the saturated thermoplastic polymer to create a thermoplastic polymer having a cellular structure with cells having an average cell size of about 100 nm or less.

In any method, the thermoplastic polymer may be selected from at least one of polycarbonate (PC), polymethyl methacrylate (PMMA), cyclic olefin copolymer (COC), polysulfone (PSU), polyphenylsulfone (PPSU), polyether ether ketone (PEEK), polylactic acid (PLA), thermoplastic urethane (TPU), low density polyethylene LDPE, high density polyethylene HDPE, ultra high molecular weight polyethylene (UHMWPE), polytetrafluoroethylene (PTFE), polypropylene (PP), polystyrene (PS), acrylonitrile butadiene styrene (ABS), polyethylene terephthalate (PET), and crystalline polyethylene terephthalate (CPET) or any combination thereof. In preferred embodiments, the methods described herein can be used to create nanocellular foams in polymers including polycarbonate (PC), polymethyl methacrylate (PMMA), cyclic olefin copolymer (COC), polysulfone (PSU), polyethylene terephthalate (PET), or any combination thereof.

In any method, a carbon dioxide concentration for producing an average cell size of 100 nm or less may be about 15% by weight or greater, or about 17.4% by weight or greater, when the polymer is polycarbonate.

In any method, a carbon dioxide concentration for producing an average cell size of 100 nm or less may be about 27.5% by weight or greater, or about 31% by weight or greater, when the polymer is polymethyl methacrylate.

In any method, a carbon dioxide concentration for producing an average cell size of 100 nm or less may be about 10% by weight or greater, or about 15% by weight or greater, when the polymer is polysulfone or polyphenylsulfone.

In any method, a carbon dioxide concentration for producing an average cell size of 100 nm or less may be about 5% by weight or greater, or about 8% by weight or greater, when the polymer is a cyclic olefin copolymer.

In any method, a carbon dioxide concentration for producing an average cell size of 100 nm or less may be about 12% by weight or greater, or about 18.5% by weight or greater, when the polymer is polyethylene terephthalate.

In any method, the cellular structure may include open interconnected pores.

In any method, the step of saturating may be performed at a temperature of 0° C. or less and a pressure of 5 MPa or less.

In any method, the thermoplastic polymer may be a homopolymer.

In any method, the thermoplastic polymer may be a copolymer.

In any method, the thermoplastic polymer may be a blend of two or more polymers.

In any method, the polymer may be about 100% by weight thermoplastic polymer.

In any method, the polymer may include nonpolymer additives.
Any thermoplastic polymer foam may include an average cell size of 100 nm or less; a relative density of 50% or less; and be about 100% by weight of thermoplastic polymer.
Any thermoplastic polymer foam may be about 100% by weight of a polymer selected from at least polycarbonate, polymethyl methacrylate, polysulfone, polyphenylsulfone, cyclic olefin copolymer, polyethylene terephthalate, or a combination thereof.
Any thermoplastic polymer may have cells comprising interconnected open cells.
Any thermoplastic polymer foam may be a homopolymer.
Any thermoplastic polymer foam may be a copolymer.

Any thermoplastic polymer foam may be a blend of two or more polymers.

The low temperature liquid carbon dioxide saturation step in a solid state foaming process is advantageous for various reasons. A low temperature saturation process is a way to reach the very high concentrations needed for creating nanofoams. Furthermore, the lower temperatures allow saturation to take place at lower pressures, such as 5 MPa or less.

With the low temperature, liquid carbon dioxide saturation of polymers, nanofoams with cell sizes lower than 100 nm, and even as small as 20 nm to 30 nm, and with high porosities, can be achieved.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a flow diagram of a low saturation temperature, liquid carbon dioxide solid state foaming method;

FIG. 2 shows the CO₂ uptake in PC as a function of time at various saturation temperatures;

FIG. 3 shows the solubility of CO₂ in PC as a function of saturation temperature

FIG. 4 shows the natural logarithm of solubility of CO₂ in PC as a function of the reciprocal of saturation temperature (squares—gaseous CO₂ and diamonds—liquid CO₂);

FIG. 5 shows diffusivity of CO₂ in PC at various temperatures and 5 MPa pressure (squares represent gaseous CO₂ and diamonds represent liquid CO₂);

FIG. 6 shows glass transition temperature of PC as a function of CO₂ concentration experimental data and corresponding best-fit lines (squares); Ma et al. (diamonds) (Ma, Z., et al., “Fabrication of Microcellular Polycarbonate Foams With Unimodal or Bimodal Cell-Size Distributions Using Supercritical Carbon Dioxide as a Blowing Agent,” Cellular Plastics 50(1):55-79, 2014), and the curve represents Chow's model prediction (Chow, T. S., “Molecular Interpretation of the Glass Transition Temperature of Polymer-Diluent Systems,” Macromolecules 13:362-364, 1980);

FIG. 7 shows the relative density of PC as a function of foaming temperature for samples initially saturated at various temperatures;

FIG. 8 shows microcellular PC foam saturated at 40° C. and then foamed at 130° C. with a relative density of 44.8% and cell size 12 μm;

FIG. 9 shows a nanocellular PC foam saturated at −30° C. and then foamed at 90° C. with a relative density of 44.1% and cell size 28 nm for comparison to FIG. 9;

FIG. 10 shows cell nucleation density as a function of foaming temperature for foamed PC samples saturated at different temperatures;

FIG. 11 shows average cell size as a function of foaming temperature for foamed PC samples saturated at different temperatures;

FIGS. 12(a)-(e) show SEM micrographs of PC foam samples saturated at (a) 40° C., (b) 20° C., (c) 0° C., (d) −20° C., and (e) −30° C. of CO₂ and foamed at 90° C. (magnification: 1000× (a, b, c) and 20,000× (d, e));

FIGS. 13(a)-(e) show SEM micrographs of PC foam samples saturated at (a) 40° C., (b) 20° C., (c) 0° C., (d) −20° C., and (e) −30° C. CO₂ and foamed at 110° C. (magnification: (a, b) 1000×, (c) 4000× and (d, e) 20,000×);

FIG. 14 shows cell nucleation density of PC foams as a function of CO₂ concentration;

FIG. 15 shows a magnified center region of FIG. 13(e) (magnification 40,000×) showing the interconnectivity in the structure as manifested by the visible underlying struts;

FIG. 16 shows the CO₂ uptake in PMMA as a function of time at various saturation temperatures;

FIG. 17 shows the solubility of CO₂ in PMMA as a function of saturation temperature (squares indicate gaseous CO₂ and diamonds liquid CO₂);

FIG. 18 shows the natural logarithm of solubility of CO₂ in PMMA as a function of the reciprocal of saturation temperature (squares—gaseous CO₂ and diamonds—liquid CO);

FIG. 19 shows the diffusivity of CO₂ in PMMA as a function of saturation temperature for various regions (diamonds (region 4), squares (region 3), circles (region 2), triangles (region 1));

FIG. 20 shows the diffusivity of CO₂ in PMMA at various saturation temperatures and 5 MPa pressure (four distinct regions where diffusivity varies differently with temperature are identified);

FIG. 21 shows the glass transition temperature of PMMA as a function of CO₂ concentration (experimental data and Chow's model with z=2 are shown);

FIG. 22 shows relative density of PMMA foams as a function of foaming temperature for samples initially saturated at various temperatures;

FIGS. 23(a) and (b) show a (a) PMMA foam sample #4 with cell size 375 μm and 25.5% relative density, and (b) PMMA foam sample #35 with cell size 120 nm and 23.4% relative density;

FIG. 24 shows cell nucleation density as a function of foaming temperature for foamed PMMA samples saturated at different temperature;

FIG. 25 shows average cell size as a function of foaming temperature for foamed PMMA samples saturated at different temperatures;

FIG. 26(a)-(e) show PMMA foam SEM images of (a) sample #13, cell size 18 μm, (b) sample #21, cell size 4.8 μm, (c) sample #28, cell size 273 nm, (d) sample #34, cell size 55 nm, and (e) sample #40, cell size 49 nm (samples were foamed at 50° C.);

FIGS. 27(a)-(e) show PMMA foam SEM images of (a) sample #8, cell size 57 μm (b) sample #17, cell size 24 μm, (c) sample #23, cell size 8.4 μm, (d) sample #30, cell size 4.3 μm, and (e) sample #36, cell size 235 nm (samples were foamed at 90° C.);

FIG. 28 shows a SEM of PMMA foam sample #35, 23.4% relative density and 120 nm cell size with pores that are interconnected, indicating porous nature of the structure;

FIGS. 29(a) and (b) shows PMMA foam sample #41, 21.3% relative density, showing uniform worm-like nanostructures, wherein the width/diameter of the “worms” is about 100 nm, and (b) is a zoom-in image of (a) in the center area;

FIG. 30 shows cell nucleation density of PMMA foams as a function of CO₂ concentration;

FIGS. 31(a) and (b) show cellular morphology of grade 8007 COC nanofoams, initially saturated at 5 MPa and −30° C., and then (a) foamed at 40° C., 690 nm cell size; (b) foamed at 70° C., 600 nm cell size;

FIG. 32 shows a nanoscale hub-and-spoke structure inside a larger cell from FIG. 31(a);

FIG. 33 shows the relative density of grade 6015 COC as a function foaming temperature for samples initially saturated at various temperatures (from −30° C. to 0° C.);

FIGS. 34(a)-(d) shows cellular morphology of 6015 COC samples that were saturated at a) 0° C., b) −10° C., c) −20° C. and d) −30° C., and then foamed at 110° C. (cell structures are very similar with some large cells dispersed among many small cells, and the large cells are about 700 nm, and small cells around 100 nm);

FIG. 35 shows an open nanoporous structure of grade 6017 COC nanofoam with 90% relative density and cells size about 20 nm;

FIGS. 36(a) and (b) show cellular morphology of PSU nanofoams that were saturated at 5 MPa and −10° C., and then foamed at (a) 130° C., 61.2% relative density and (b) 150° C., 53.2% relative density;

FIGS. 37(a) and (b) show cellular morphology of PPSU nanofoams that were saturated at 5 MPa and −10° C., and then foamed at (a) 130° C., 78.9% relative density and (b) 170° C., 60.7% relative density; and

FIG. 38 shows microstructure of 43% relative density PET foam with 1 μm large cells and 100-300 nm nanostructures inside.

### DETAILED DESCRIPTION

The present disclosure describes methods of making nanocellular foams using low-temperature liquid carbon dioxide saturation of polymers.

The particulars shown herein are by way of example and for purposes of illustrative discussion of the preferred embodiments of the present invention only and are presented in the cause of providing what is believed to be the most useful and readily understood description of the principles and conceptual aspects of various embodiments of the invention. In this regard, no attempt is made to show structural details of the invention in more detail than is necessary for the fundamental understanding of the invention, the description taken with the drawings and/or examples making apparent to those skilled in the art how the several forms of the invention may be embodied in practice.

As used herein and unless otherwise indicated, the terms “a” and “an” are taken to mean “one”, “at least one” or “one or more”. Unless otherwise required by context, singular terms used herein shall include pluralities and plural terms shall include the singular.

Unless the context clearly requires otherwise, throughout the description and the claims, the words ‘comprise’, ‘comprising’, and the like are to be construed in an inclusive sense as opposed to an exclusive or exhaustive sense; that is to say, in the sense of “including, but not limited to”. Words using the singular or plural number also include the plural and singular number, respectively. Additionally, the words “herein,” “above,” and “below” and words of similar import, when used in this application, shall refer to this application as a whole and not to any particular portions of the application.

All of the references cited herein are incorporated by reference. Aspects of the disclosure can be modified, if necessary, to employ the systems, functions, and concepts of the above references and application to provide yet further embodiments of the disclosure. These and other changes can be made to the disclosure in light of the detailed description.

Any definitions and explanations are meant and intended to be controlling in any future construction unless clearly and unambiguously modified in the following examples or when application of the meaning renders any construction meaningless or essentially meaningless. In cases where the construction of the term would render it meaningless or essentially meaningless, the definition should be taken from Webster's Dictionary, 3rd Edition or a dictionary known to those of skill in the art, such as the Oxford Dictionary of Biochemistry and Molecular Biology (Ed. Anthony Smith, Oxford University Press, Oxford, 2004).

In this application, the “average cell size” is calculated by taking the average cell diameters of at least 50 cells such as from an SEM micrograph.

In this application, “cell nucleation density” is calculated using the following equation:

$${N}_{f} = {( \frac{{nM}^{2}}{A} )}^{\frac{3}{2}}$$

wherein, n is the number of bubbles in the micrograph, A is the area of the micrograph in cm², and M is the magnification factor, then (n/A/M²) gives the area bubble density or the number of bubbles per cm² of the foam. By cubing the line density, the number of bubbles per cm³ of the foam N_{f} can be estimated. The procedure is described by Kumar et al. (Kumar, V., and J. E. Weller, “Production of Microcellular Polycarbonate Using Carbon Dioxide for Bubble Nucleation,” Journal of Eng. For Ind. 116:413-20, 1994).

In this application, the relative density is the density of a foamed polymer divided by the density of the initially unfoamed and unsaturated polymer.

As discussed above, a step in a solid-state foaming process is to saturate the polymer with a blowing agent, for example carbon dioxide. A combination of saturation pressure and saturation temperature determines the amount of physical blowing agent absorbed, and to a large extent, the subsequent foam structure. Traditionally, the saturation temperature used is around room temperature (20-30° C.) and saturation pressure is in the range of 1-7 MPa. At these conditions, carbon dioxide exist as gas. In order to achieve higher gas solubility and faster sorption, supercritical carbon dioxide has been used. To achieve supercritical carbon dioxide, the saturation temperature is above 31.1° C. and the saturation pressure is above 7.3 MPa. However, low saturation temperatures of about and/or below 0° C., have not been used. At low temperatures, depending on the specific pressure, the carbon dioxide can be in either a gaseous or a liquid state. The present disclosure relates to using any combinations of temperature and pressure to saturate the polymer with liquid carbon dioxide. The conditions at which carbon dioxide is a liquid are known.

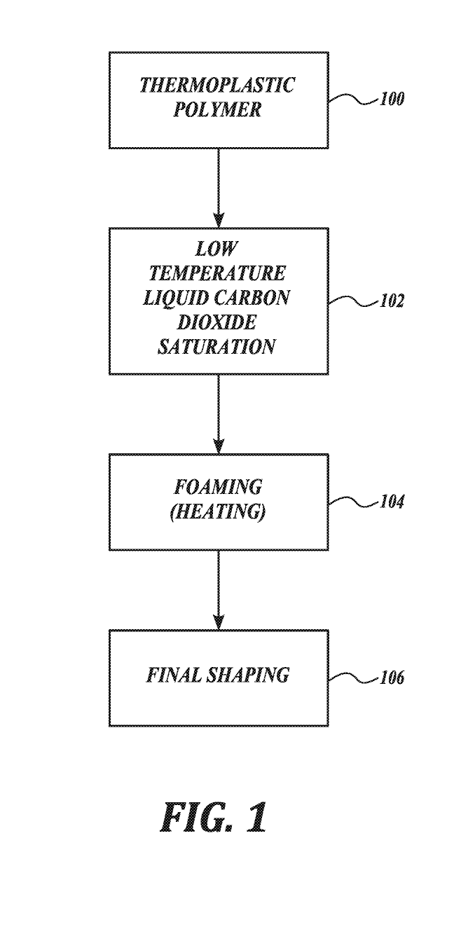

Referring to FIG. 1, a flow diagram of a low temperature liquid carbon dioxide solid-state foaming method for making nanocellular foams is illustrated. The method includes a step for obtaining or providing a thermoplastic polymer, block 100, a step for saturation of the thermoplastic polymer at conditions which produce liquid carbon dioxide, block 102, and a step for foaming or heating, block 104. The method may additionally comprise a step for final shaping of the thermoplastic polymer foam into a product, block 106.

The thermoplastic polymer of block 100 may be a homopolymer, a copolymer, a blend of polymers, or a multipolymer (two or more layered polymers). The term polymer may refer to the singular or plural form. A homopolymer is composed of a single type of monomer units. Copolymers are composed of two or more types of monomer units. Physical blends of polymers are mechanically mixed polymers. Multipolymers or layered polymers of any of the three categories may also be used in the method. The thermoplastic polymer for use in the method can be a solid, noncellular material that initially may have been produced via a thermoforming, vacuum-molding, melt-extrusion process, or other conventional molding process for thermoplastic polymers. Any thermoplastic polymer used in the method may comprise about 100% by weight of the thermoplastic polymer or polymers. Nonpolymer additives for imparting certain properties may comprise a small percentage of the thermoplastic polymer. The starting thermoplastic polymer may be commercially available. In certain embodiments, the thermoplastic polymer may comprise particles. In certain further embodiments, these particles include 1-, 2-, and 3-dimensional particles. In certain further embodiments, the particles are in microphased or nanophased form. For example, the particles could include nanoclays, carbon nanofibers, carbon nanoparticles, and the like. Nanofoams can be made according to the methods described herein with polymers including, but not limited to polycarbonate (PC), polymethyl methacrylate (PMMA), cyclic olefin copolymer (COC), polysulfone (PSU), polyphenylsulfone (PPSU), polyether ether ketone (PEEK), polylactic acid (PLA), thermoplastic urethane (TPU), low density polyethylene LDPE, high density polyethylene HDPE, ultra high molecular weight polyethylene (UHMWPE), polytetrafluoroethylene (PTFE), polypropylene (PP), polystyrene (PS), acrylonitrile butadiene styrene (ABS), polyethylene terephthalate (PET), and crystalline polyethylene terephthalate (CPET). In preferred embodiments, the methods described herein can be used to create nanocellular foams from polymers including polycarbonate (PC), polymethyl methacrylate (PMMA), cyclic olefin copolymer (COC), polysulfone (PSU), and polyethylene terephthalate (PET).

The shape of the starting thermoplastic polymer is not limited, and may be a noncellular sheet, film, rod, or any other shape. Solid, noncellular finished products may also be used as the starting material in the method. Alternatively, the thermoplastic polymer is finished by molding, or otherwise, in block 106 after the thermoplastic polymer has been converted to a foam.

Block 102 is for saturating the thermoplastic polymer of block 100 with a blowing agent such as liquid carbon dioxide. The ranges of temperature and pressure to produce liquid carbon dioxide may vary. Low temperatures can be preferred. The low temperature may vary with the specific thermoplastic polymer. Block 102 results in a thermoplastic polymer saturated with the carbon dioxide at a concentration suitable for creating nanofoams, the lower end of such concentration is described below. While carbon dioxide is used as a representative blowing agent, in other embodiments, other non-reacting blowing agents compatible with the thermoplastic polymer can be used. Blowing agents may include carbon dioxide, nitrogen, or other non-reacting agents. The blowing agent can be either a gas or a liquid at the chosen temperature and pressure.

The thermoplastic polymer is placed in a pressurized vessel, the inside of which is maintained at a low temperature and filled with the gas or liquid blowing agent for a time sufficient to saturate the thermoplastic polymer with the gas or liquid. In certain embodiments, the low temperature is below 0° C., −10° C., −20° C., −30° C., or −40° C. In certain embodiments, the saturation pressure in the pressurized vessel is from greater than 0 MPa to about 30 MPa. In certain embodiments, the saturation pressure can be about 10 MPa or less. In certain embodiments, the saturation pressure can be about 5 MPa or less. In certain embodiments, the saturation pressure can be about 5 MPa.

Liquid phase carbon dioxide is not supercritical phase fluid carbon dioxide. The lower pressure range of liquid phase carbon dioxide is at or greater than the triple point pressure and less than the critical point pressure, which marks the boundary between the liquid and gas phases. The upper pressure range of liquid carbon dioxide for use in the disclosed methods is for practical purposes about 30 MPa. The temperature range of liquid carbon dioxide is at or greater than the triple point temperature and less than the critical point temperature. The well-known triple point pressure and temperature of carbon dioxide is about 0.518 MPa at −56.6° C. The well-known critical point pressure and temperature of carbon dioxide is about 7.38 MPa at 31.1° C. For any embodiment calling for the use of liquid carbon dioxide saturation, the temperature and pressure can be in the ranges described above that define the liquid phase of carbon dioxide. Thus, any combination of temperature and pressure that produces liquid carbon dioxide may be used. For example, a temperature range of −56.6° C. to 31.1° C. and a pressure range of 0.518 MPa to 30 MPa are suitable.

The low temperatures may be achieved by placing the pressure vessel within a freezer capable of achieving the low temperature. Alternatively, a refrigerant can be circulated through the pressurized vessel.

When the saturated thermoplastic polymer is heated to a temperature greater than the glass transition temperature of the saturated polymer, the thermoplastic polymer undergoes nucleation and cell expansion to produce a foam. It has been found that certain thermoplastic polymers can be created with cell sizes of about 100 nm or less, provided that the concentration of carbon dioxide dissolved in the thermoplastic polymer is within or greater than a certain range. The concentration that is needed to produce a nanofoam can depend on the specific thermoplastic polymer used. For example, when the thermoplastic polymer is polycarbonate, the lower end of the concentration range of dissolved carbon dioxide needed to create an average cell size of about 100 nm is from about 15% to about 17.4% by weight. When the thermoplastic polymer is polymethyl methacrylate, the lower end of the concentration range of dissolved carbon dioxide needed to create an average cell size of 100 nm or less is from about 27.5% to about 31% by weight. When the thermoplastic polymer is polysulfone or polyphenylsulfone, the lower end of the concentration range of dissolved carbon dioxide needed to create an average cell size of 100 nm or less is from about 10% to about 15% by weight. When the thermoplastic polymer is a cyclic olefin copolymer, the lower end of the concentration range of dissolved carbon dioxide needed to create an average cell size of 100 nm or less is from about 5% to about 8% by weight. When the thermoplastic polymer is polyethylene terephthalate, the lower end of the concentration range of dissolved carbon dioxide needed to create an average cell size of 100 nm or less is from about 12% to 18.5% by weight. The above ranges define the concentration of carbon dioxide at which microcellular foams transition to nanocellular foams (cells about 100 nm or less). It should be noted that a concentration greater than the above ranges are also suitable to create nanofoams.

From block 102, the method enters block 104. Block 104 is for foaming the saturated thermoplastic polymer by increasing the temperature of the saturated thermoplastic polymer above the glass transition temperature. The temperature can be raised using any number of heating devices, such as but not limited to a hot oil bath, hot gas, radiation, ultrasound, hot plate, or the like. The glass transition temperature of each saturated polymer will be different. Also, because the dissolved carbon dioxide will lower the glass transition temperature of the thermoplastic polymer, the glass transition temperature will be lower than the glass transition temperature of unsaturated thermoplastic polymer. The glass transition temperature can be determined by following the examples described herein. Alternatively, there are models that can predict the glass transition temperature. The lowest foaming temperature can be determined from such experiments or models. The foaming temperature may also determine whether the resulting structure has closed cells or an open porous network of cells. Generally, higher foaming temperatures may result in a more open porous structure. Depending on the particular polymer, the foaming temperature can be in the range of 20° C. to 200° C. However, the foaming temperature can vary based on the polymer and concentration of carbon dioxide, so the above range should be taken as a general starting guideline.

After the thermoplastic polymer is foamed in block 104, the foam or any resulting structure may optionally be processed by any shaping method in block 106 into a finished product. For example, sheets of foamed thermoplastic polymer may undergo molding to form containers for food or beverages. Other foamed thermoplastic polymers may undergo machine shaping, such as cutting and polishing, to achieve certain dimensions or shapes of the finished products.

Thermoplastic polymer foams will be useful as structural parts in many industries, for example, the automotive, aerospace, and building industries. These industries have been looking for ways to reduce weight in structural parts (while maintaining mechanical properties) to reduce costs and energy consumption. Thermoplastic nanofoams can exhibit improved mechanical properties. For example, nanocellular PC may have improved mechanical properties, such as impact resistance.

In certain embodiments, nanocellular foams can be created with interconnecting pores. Nanocellular PC, PMMA, COC, and PSU, for example, can be produced with a nano-sized open porous structure. An open porous structure is permeable to certain gases or liquids. Membranes based on this nanoporous structure can be used as separators in batteries and filtration membranes in biological, pharmaceutical, hemodialysis, waste water recovery, food and beverage processing, and gas separation. These nanoporous membranes can provide improved properties and reduced cost over the current membrane materials. For example, nanoporous PSU can be used as a battery separator in a Li-ion battery. The high service temperature of PSU ensures the mechanical integrity of the separator at higher temperature, and thus greatly enhances battery safety.

PC, PMMA and COC nanofoams have applications as window materials to replace traditional glass windows. Clear plastic foam windows which are thermally insulating are attractive since this type window can conserve energy for buildings and reduce the structural weight of mobile housing. Nanocellular PC, PMMA and COC foams can be produced that have weight reductions of over 50% compared to noncellular material and may have improved light transmission.

Polycarbonate (PC)

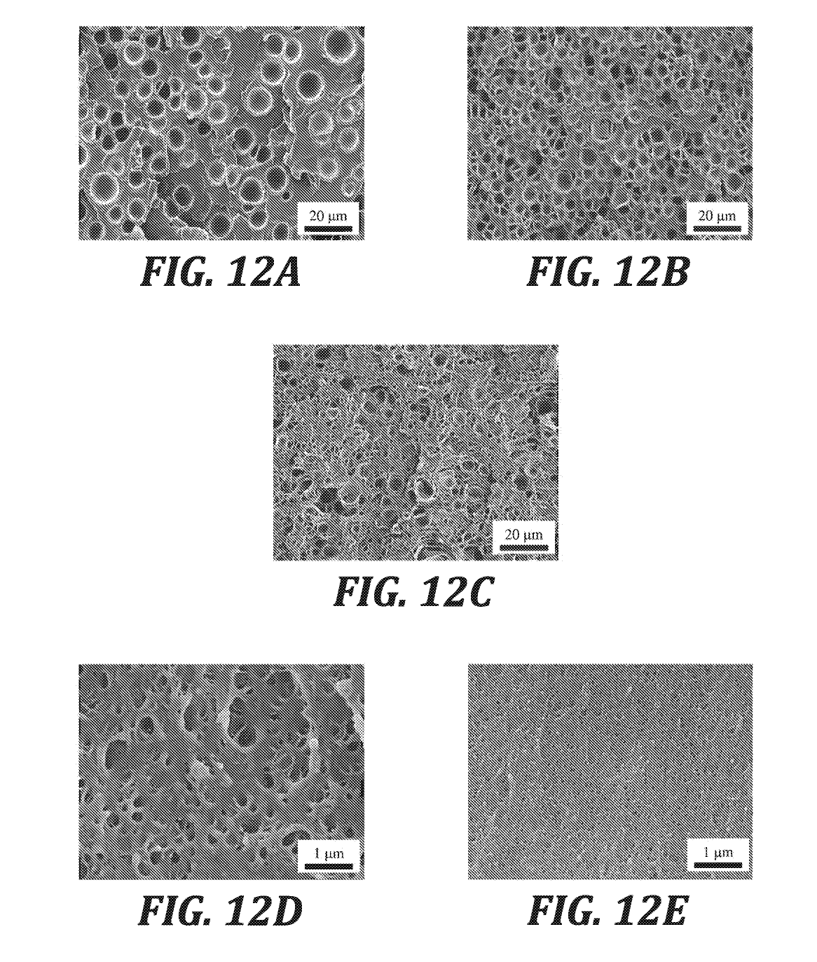

Referring to Table 1 below, a summary of the processing conditions of PC are shown. Nanocellular foams with closed cells are shown in FIGS. 12(d) and (e), wherein the polymer was saturated with liquid carbon dioxide at −20° C. and −30° C. at 5 MPa, respectively, and foamed at 90° C. An open cellular structure can be made by increasing the foaming temperature. FIG. 15 shows an open cell porous structure when the foaming temperature was increased to 110° C. Table 1 shows that the transition from microcellular to nanocellular foams starts at a carbon dioxide concentration of from about 15% to about 17.4% by weight. In addition to the saturation temperatures of Table 1 for carbon dioxide, a temperature range of −56.6° C. to 31.1° C. and a pressure range of 0.518 MPa to 30 MPa are suitable as well to achieve liquid carbon dioxide.

TABLE 1
Summary of processing conditions and foam characteristics of PC.

| | Saturation | | | | Cell | |
|---|---|---|---|---|---|---|
| | temperature | | Foaming | | nucleation | Average |
| | (° C.) at | CO₂ | temperature | Relative | density | cell size |
| Sample # | 5 MPa | concentration | (° C.) | density | (cells/cm³) | (μm) |
| 1 | 40 | 7.2% | 80 | 91.3% | 2.9 × 10⁸ | 7.1 |
| 2 | 40 | 7.2% | 90 | 83.9% | 4.9 × 10⁸ | 8.1 |
| 3 | 40 | 7.2% | 100 | 74.4% | 6.3 × 10⁸ | 8.5 |
| 4 | 40 | 7.2% | 110 | 65.5% | 7.0 × 10⁸ | 9.4 |
| 5 | 40 | 7.2% | 120 | 55.4% | 6.6 × 10⁸ | 10.9 |
| 6 | 40 | 7.2% | 130 | 44.8% | 6.4 × 10⁸ | 12.1 |
| 7 | 20 | 10.8% | 70 | 82.1% | 4.2 × 10⁹ | 3.5 |
| 8 | 20 | 10.8% | 90 | 68.5% | 6.7 × 10⁹ | 4.2 |
| 9 | 20 | 10.8% | 110 | 48.9% | 8.5 × 10⁹ | 4.9 |
| 10 | 20 | 10.8% | 130 | 31.9% | 6.4 × 10⁹ | 6.7 |
| 11 | 0 | 15.0% | 50 | 84.3% | 2.2 × 10¹⁰ | 1.1 |
| 12 | 0 | 15.0% | 70 | 66.8% | 3.8 × 10¹⁰ | 1.6 |
| 13 | 0 | 15.0% | 90 | 52.8% | 3.6 × 10¹⁰ | 1.7 |
| 14 | 0 | 15.0% | 110 | 39.9% | 2.8 × 10¹¹ | 1.2 |
| 15 | 0 | 15.0% | 130 | 27.0% | 1.2 × 10¹¹ | 2.2 |
| 16 | −20 | 17.4% | 50 | 73.9% | 2.5 × 10¹¹ | 0.779 |
| 17 | −20 | 17.4% | 70 | 61.3% | 3.6 × 10¹² | 0.317 |
| 18 | −20 | 17.4% | 90 | 44.3% | 1.9 × 10¹³ | 0.136 |
| 19 | −20 | 17.4% | 110 | 31.7% | 3.6 × 10¹³ | 0.201 |
| 20 | −30 | 18.7% | 60 | 61.9% | 2.7 × 10¹³ | 0.023 |
| 21 | −30 | 18.7% | 70 | 56.2% | 4.1 × 10¹⁴ | 0.021 |
| 22 | −30 | 18.7% | 80 | 49.4% | 6.7 × 10¹⁴ | 0.029 |
| 23 | −30 | 18.7% | 90 | 44.1% | 8.1 × 10¹⁴ | 0.028 |
| 24 | −30 | 18.7% | 100 | 37.7% | 1.3 × 10¹⁵ | 0.029 |
| 25 | −30 | 18.7% | 110 | 41.4% | 2.0 × 10¹⁵ | 0.031 |

Polymethyl Methacrylate (PMMA)

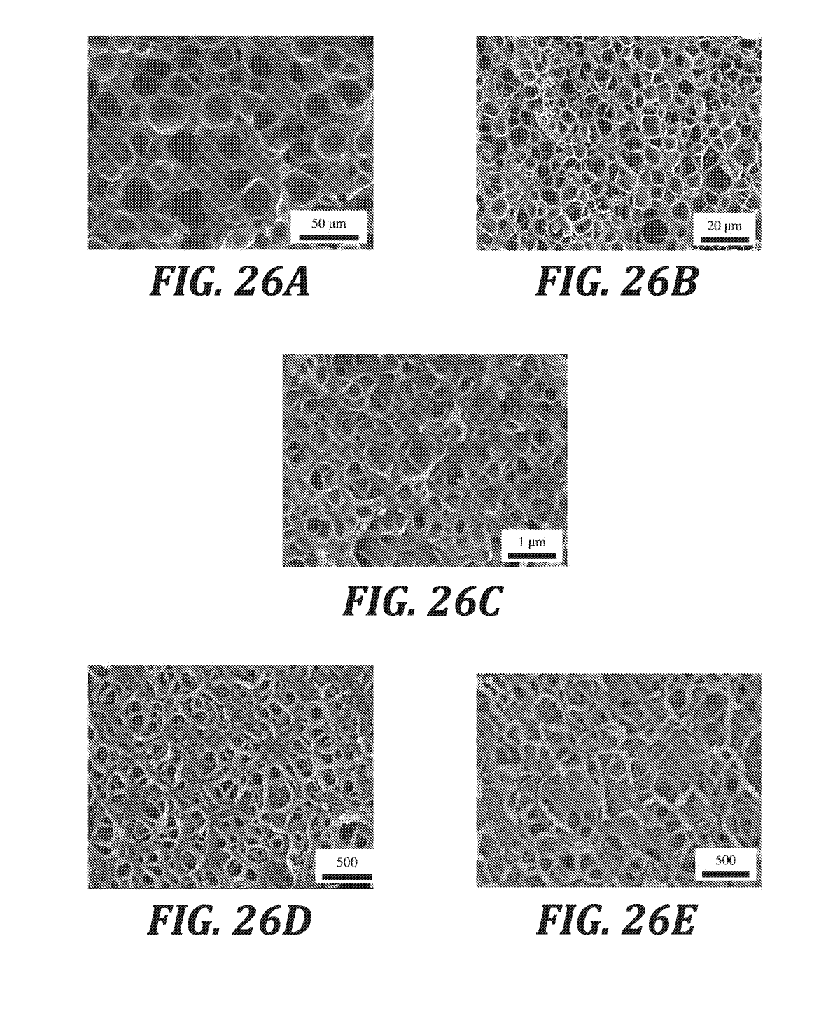

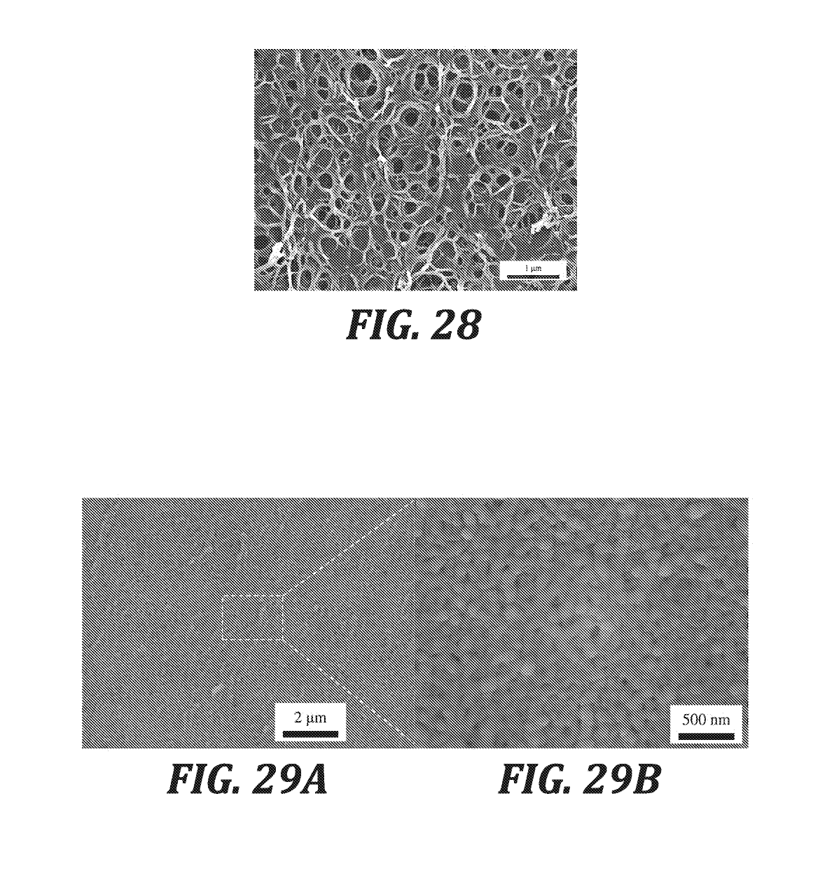

Referring to Table 2 below, a summary of the processing conditions of PMMA is shown. Nanocellular foams with an open porous structure are shown in FIGS. 26(d) and (e), wherein the polymer was saturated with liquid carbon dioxide at 5 MPa at −20° C. and −30° C., respectively, and foamed at 50° C. Higher foaming temperatures can increase the open cellular structure. FIG. 28 shows a porous open cell structure when the foaming temperature was increased to 70° C. Temperatures higher than 70° C. resulted in the worm-like structures shown in FIG. 29(b). Table 2 shows that the transition from microcellular to nanocellular foams starts at a carbon dioxide concentration of from about 27.5% to about 31% by weight. In addition to the saturation temperatures of Table 2 for carbon dioxide, a temperature range of −56.6° C. to 31.1° C. and a pressure range of 0.518 MPa to 30 MPa are suitable as well to achieve liquid carbon dioxide.

TABLE 2
Summary of processing conditions and foam characteristics of PMMA.

| | Saturation | | | | Cell | |
|---|---|---|---|---|---|---|
| | temperature | | Foaming | | nucleation | Average |
| | (° C.) at | CO₂ | temperature | Relative | density | cell size |
| Sample# | 5 MPa | concentration | (° C.) | density | (cells/cm³) | (μm) |
| 1 | 80 | 5.0% | 100 | 98.9% | 4.75 × 10³ | 115 |
| 2 | 80 | 5.0% | 105 | 93.6% | 9.18 × 10³ | 147 |
| 3 | 80 | 5.0% | 110 | 55.7% | 6.18 × 10⁴ | 233 |
| 4 | 80 | 5.0% | 115 | 25.5% | 7.37 × 10⁴ | 375 |
| 5 | 40 | 11.0% | 60 | 99.5% | 9.18 × 10³ | 42 |
| 6 | 40 | 11.0% | 70 | 74.9% | 3.86 × 10⁵ | 96 |
| 7 | 40 | 11.0% | 80 | 40.0% | 6.49 × 10⁶ | 61 |
| 8 | 40 | 11.0% | 90 | 28.0% | 1.03 × 10⁷ | 54 |
| 9 | 40 | 11.0% | 100 | 17.9% | 1.45 × 107 | 57 |
| 10 | 40 | 11.0% | 110 | 8.7% | 2.22 × 10⁷ | 72 |
| 11 | 20 | 18.9% | 30 | 98.8% | 9.49 × 10⁵ | 14 |
| 12 | 20 | 18.9% | 40 | 69.2% | 5.59 × 10⁷ | 18 |
| 13 | 20 | 18.9% | 50 | 52.8% | 1.26 × 10⁸ | 18 |
| 14 | 20 | 18.9% | 60 | 40.4% | 1.32 × 10⁸ | 18 |
| 15 | 20 | 18.9% | 70 | 32.2% | 1.46 × 10⁸ | 23 |
| 16 | 20 | 18.9% | 80 | 23.8% | 2.04 × 10⁸ | 19 |
| 17 | 20 | 18.9% | 90 | 17.0% | 2.04 × 10⁸ | 24 |
| 18 | 20 | 18.9% | 100 | 11.0% | 2.22 × 10⁸ | 27 |
| 19 | 0 | 27.5% | 20 | 99.0% | 2.50 × 10⁸ | 1.8 |
| 20 | 0 | 27.5% | 30 | 65.9% | 3.73 × 10¹⁰ | 2.2 |
| 21 | 0 | 27.5% | 50 | 46.3% | 1.05 × 10¹⁰ | 4.8 |
| 22 | 0 | 27.5% | 70 | 36.2% | 5.60 × 10⁹ | 6.7 |
| 23 | 0 | 27.5% | 90 | 22.4% | 5.55 × 10⁹ | 8.4 |
| 24 | 0 | 27.5% | 110 | 8.3% | 2.53 × 10⁹ | 13.3 |
| 25 | −10 | 31.0% | 10 | 98.0% | 8.74 × 10¹¹ | 0.509 |
| 26 | −10 | 31.0% | 20 | 74.1% | 2.52 × 10¹³ | 0.173 |
| 27 | −10 | 31.0% | 30 | 57.6% | 2.91 × 10¹³ | 0.185 |
| 28 | −10 | 31.0% | 50 | 38.8% | 2.71 × 10¹³ | 0.273 |
| 29 | −10 | 31.0% | 70 | 26.7% | 1.42 × 10¹² | 1.1 |
| 30 | −10 | 31.0% | 90 | 16.1% | 6.89 × 10¹⁰ | 4.3 |
| 31 | −20 | 33.5% | 0 | 98.9% | 8.91 × 10¹² | 0.053 |
| 32 | −20 | 33.5% | 10 | 83.0% | 5.50 × 10¹³ | 0.039 |
| 33 | −20 | 33.5% | 30 | 50.9% | 2.07 × 10¹⁴ | 0.056 |
| 34 | −20 | 33.5% | 50 | 34.3% | 5.56 × 10¹⁴ | 0.055 |
| 35 | −20 | 33.5% | 70 | 23.4% | 1.54 × 10¹⁴ | 0.120 |
| 36 | −20 | 33.5% | 90 | 13.65% | 6.57 × 10¹³ | 0.235 |
| 37 | −30 | 37.0% | 0 | 95.9% | 3.56 × 10¹³ | 0.054 |
| 38 | −30 | 37.0% | 10 | 75.3% | 5.72 × 10¹³ | 0.045 |
| 39 | −30 | 37.0% | 30 | 46.0% | 3.01 × 10¹⁴ | 0.035 |
| 40 | −30 | 37.0% | 50 | 31.3% | 3.09 × 10¹⁴ | 0.049 |
| 41 | −30 | 37.0% | 70 | 21.3% | N/A | N/A |
| 42 | −30 | 37.0% | 90 | 24.1% | N/A | N/A |

Cyclic Olefin Copolymer (COC)

Three different grades of COC with varying glass transition temperatures (T_{g}) were foamed using low temperature liquid carbon dioxide saturation. T_{g} for 8007, 6015, 6017 COC are 78° C., 158° C., and 178° C., respectively. The grades of COC pertain to the products available under the TOPAS® mark by TOPAS Advanced Polymers of Germany.

### Grade 8007 COC

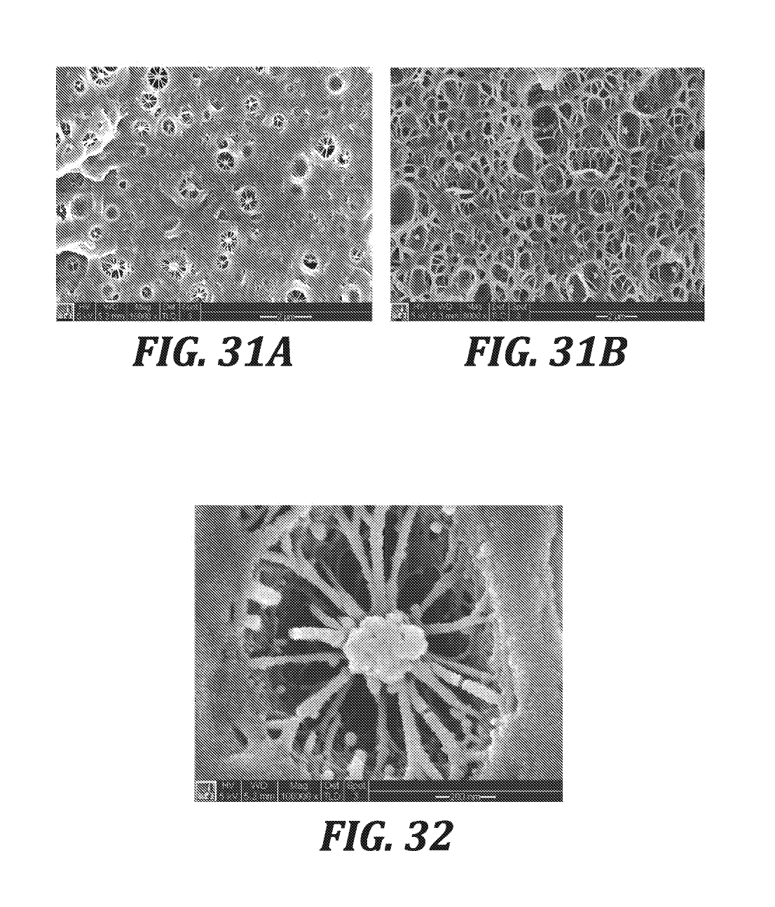

COC FIGS. 31(a) and (b) show cellular morphology of grade 8007 COC nanofoams. The COC polymers were initially saturated with liquid carbon dioxide at 5 MPa and −30° C., and then foamed at 40° C. and 60° C., respectively. Nanoscale features can be seen inside the larger cells, with cell size of larger cells being about 600-700 nm. COC produced an interesting nanofeature shown in FIGS. 31(a) and 32. The hub-and-spoke structure was produced from COC initially saturated with liquid carbon dioxide at 5 MPa and −30° C., and foamed at 40° C. The hub-and-spoke structure has nano-sized features. In addition to the pressures and temperatures described, a temperature range of −56.6° C. to 31.1° C. and a pressure range of 0.518 MPa to 30 MPa are suitable as well to achieve liquid carbon dioxide.

### Grade 6015 COC

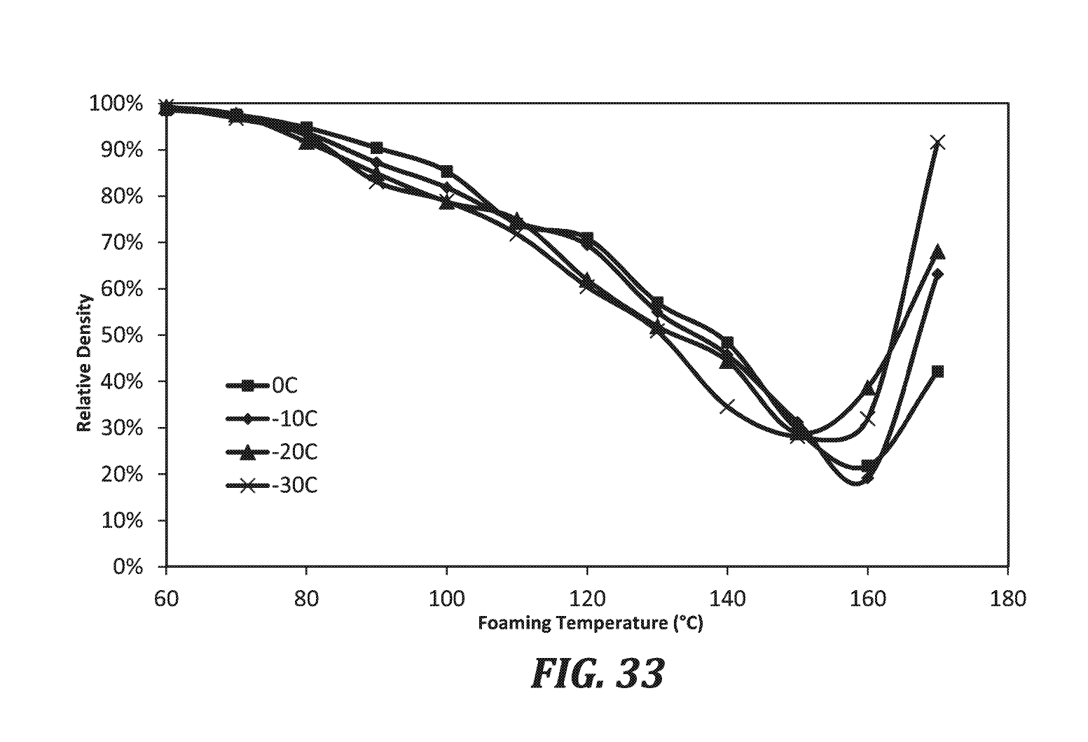

A range of densities of 6015 COC were achieved by varying the foaming temperature. Relative densities as a function of foaming temperature are plotted in FIG. 33. A relative density as low as 15% was obtained.

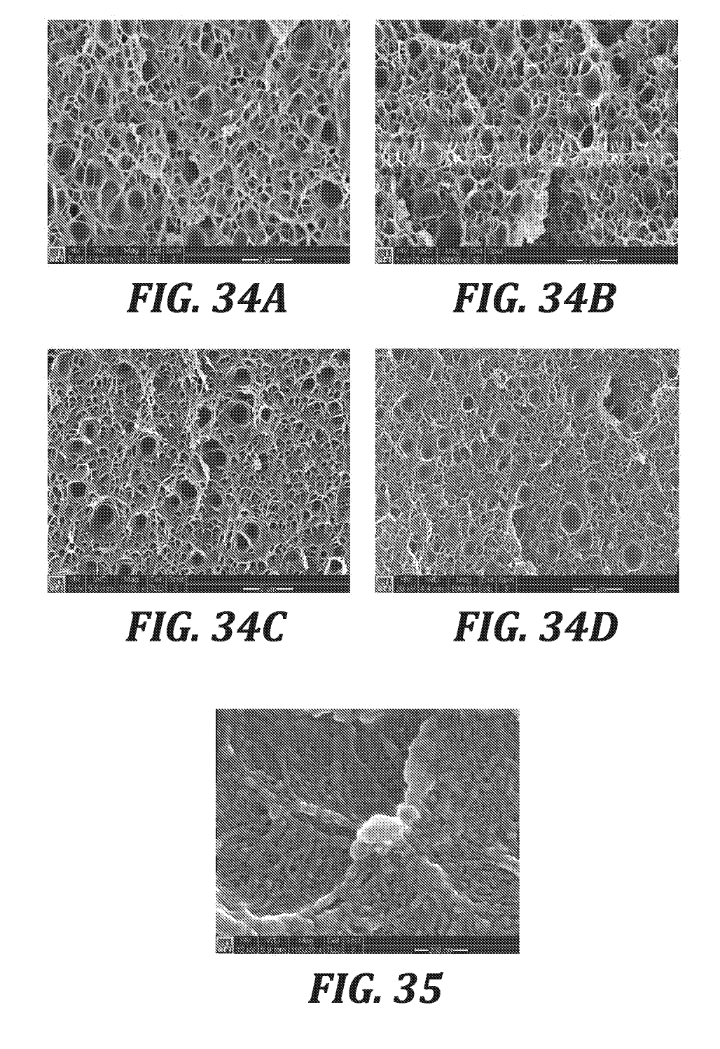

Cellular morphologies of COC foams are shown in FIGS. 34(a), (b), (c), and (d). The FIGURES show the cellular morphology of 6015 COC polymers that were saturated with liquid carbon dioxide at 5 MPa and (a) 0° C., (b) −10° C., (c) −20° C. and (d) −30° C., and then foamed at 110° C. The cell structures are very similar with some large cells dispersed among many small cells. The large cells are about 700 nm and the small cells about 100 nm. In addition to the pressures and temperatures described, a temperature range of −56.6° C. to 31.1° C. and a pressure range of 0.518 MPa to 30 MPa are suitable as well to achieve liquid carbon dioxide.

### Grade 6017 COC

FIG. 35 shows the cell morphology of grade 6017 COC nanofoams, with 90% relative density and 20 nm cell size. The COC polymer was saturated with liquid carbon dioxide at 5 MPa and −10° C., then foamed at 90° C. for 30 s. Also, FIG. 35 shows an open nanoporous structure with cells of about 20 nm. In addition to the pressures and temperatures described, a temperature range of −56.6° C. to 31.1° C. and a pressure range of 0.518 MPa to 30 MPa are suitable as well to achieve liquid carbon dioxide.

Polysulfone (PSU)

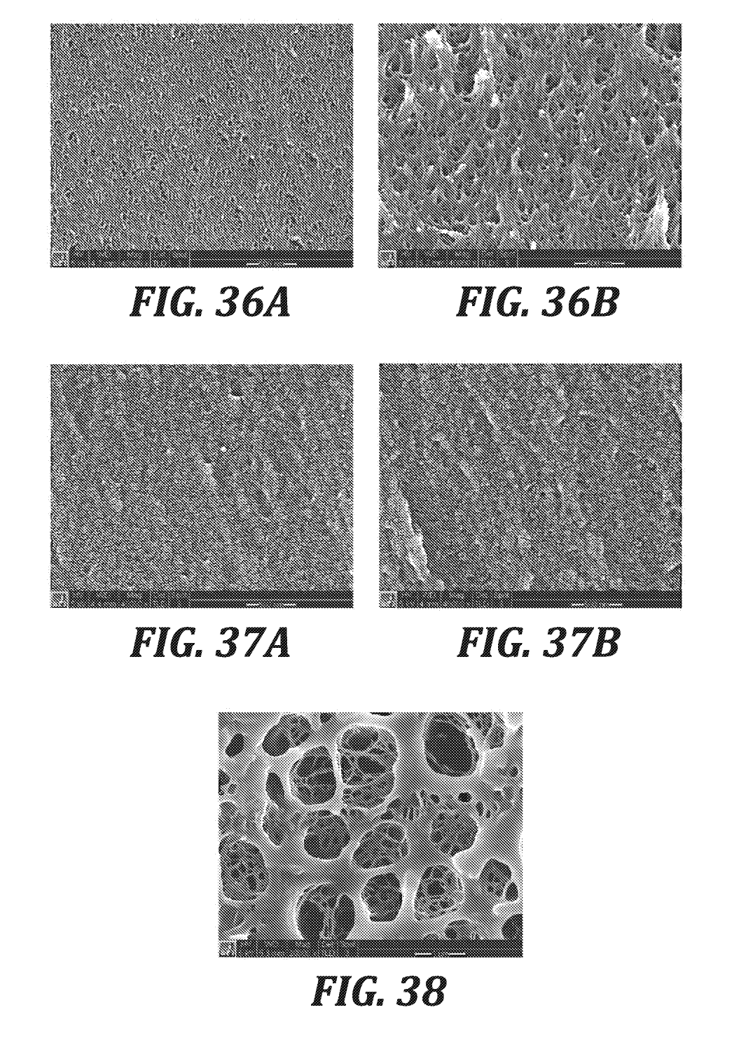

PSU was selected as a representative material for investigating the low temperature liquid carbon dioxide saturation effects of high glass transition temperature (T_{g}) polymers. The T_{g} is 185° C. FIGS. 36(a) and (b) show the cellular morphology of PSU nanofoams. PSU polymers were saturated with liquid carbon dioxide at 5 MPa and −10° C., and then foamed at (a) 130° C., resulting in a 61.2% relative density, and (b) 150° C., resulting in a 53.2% relative density. Both foams have a cell size around 40 nm. However, the cellular morphology is different. FIG. 36(a) shows a closed nanocellular structure, whereas FIG. 36(b) has an open nanoporous structure. In addition to the pressures and temperatures described, a temperature range of −56.6° C. to 31.1° C. and a pressure range of 0.518 MPa to 30 MPa are suitable as well to achieve liquid carbon dioxide.

Polyphenylsulfone (PPSU)

PPSU was selected as another representative material for investigating the low temperature liquid carbon dioxide saturation effects of high glass transition temperature polymers. The T_{g} of PPSU is 220° C. FIGS. 37(a) and (b) show the cellular morphology of PPSU nanofoams. The polymers were initially saturated with liquid carbon dioxide at 5 MPa and −10° C., and then foamed at 130° C. and 170° C., respectively. Both foams have a cell size of about 40-50 nm. The relative density is about 78.9% and 60.7%, respectively, for a foaming temperature of 130° C. and 170° C. In addition to the pressures and temperatures described, a temperature range of −56.6° C. to 31.1° C. and a pressure range of 0.518 MPa to 30 MPa are suitable as well to achieve liquid carbon dioxide.

Polyethylene Terephthalate (PET)

PET was selected as a representative polymer for investigating the low temperature liquid carbon dioxide saturation effects of semi-crystalline polymers. FIG. 38 shows the microstructure of PET foam. The PET polymer was initially saturated with liquid carbon dioxide at 5 MPa and −30° C., and then foamed at 20° C. The microstructure is composed of 1 μm cells with 100-300 nm nanostructures inside. A relative density of the foamed PET is about 45%. In addition to the pressures and temperatures described, a temperature range of −56.6° C. to 31.1° C. and a pressure range of 0.518 MPa to 30 MPa are suitable as well to achieve liquid carbon dioxide.

Representative embodiments may include the following. It should be understood that features of any one embodiment may be combined with the features of any other embodiment to produce a combination.

Any method of making a thermoplastic polymer foam may include saturating a noncellular thermoplastic polymer with liquid carbon dioxide to produce a carbon dioxide saturated thermoplastic polymer; and heating the saturated thermoplastic polymer to create a thermoplastic polymer having a cellular structure with cells having an average cell size of about 100 nm or less.

In any method, the thermoplastic polymer may be selected from at least one of polycarbonate (PC), polymethyl methacrylate (PMMA), cyclic olefin copolymer (COC), polysulfone (PSU), polyphenylsulfone (PPSU), polyether ether ketone (PEEK), polylactic acid (PLA), thermoplastic urethane (TPU), low density polyethylene LDPE, high density polyethylene HDPE, ultra high molecular weight polyethylene (UHMWPE), polytetrafluoroethylene (PTFE), polypropylene (PP), polystyrene (PS), acrylonitrile butadiene styrene (ABS), polyethylene terephthalate (PET), and crystalline polyethylene terephthalate (CPET) or any combination thereof. In preferred embodiments, the methods described herein can be used to create nanocellular foams in polymers including polycarbonate (PC), polymethyl methacrylate (PMMA), cyclic olefin copolymer (COC), polysulfone (PSU), polyethylene terephthalate (PET), or any combination thereof.

In any method, a carbon dioxide concentration for producing an average cell size of 100 nm or less may be about 15% by weight or greater, or about 17.4% by weight or greater, when the polymer is polycarbonate.

In any method, a carbon dioxide concentration for producing an average cell size of 100 nm or less may be about 27.5% by weight or greater, or about 31% by weight or greater, when the polymer is polymethyl methacrylate.

In any method, a carbon dioxide concentration for producing an average cell size of 100 nm or less may be about 10% by weight or greater, or about 15% by weight or greater, when the polymer is polysulfone or polyphenylsulfone.

In any method, a carbon dioxide concentration for producing an average cell size of 100 nm or less may be about 5% by weight or greater, or about 8% by weight or greater, when the polymer is a cyclic olefin copolymer.

In any method, a carbon dioxide concentration for producing an average cell size of 100 nm or less may be about 12% by weight or greater, or about 18.5% by weight or greater, when the polymer is polyethylene terephthalate.

In any method, the cellular structure may include open interconnected pores.

In any method, the step of saturating may be performed at a temperature of 0° C. or less and a pressure of 5 MPa or less.

In any method, the thermoplastic polymer may be a homopolymer.

In any method, the thermoplastic polymer may be a copolymer.

In any method, the thermoplastic polymer may be a blend of two or more polymers.

In any method, the polymer may be about 100% by weight thermoplastic polymer.

In any method, the polymer may include nonpolymer additives.

In any method, the temperature range of liquid carbon dioxide can be −56.6° C. to 31.1° C. and the pressure range of liquid carbon dioxide can be 0.518 MPa to 30 MPa.
Any thermoplastic polymer foam may include an average cell size of 100 nm or less; a relative density of 50% or less; and be about 100% by weight of thermoplastic polymer.
Any thermoplastic polymer foam may be about 100% by weight of a polymer selected from at least polycarbonate, polymethyl methacrylate, polysulfone, polyphenylsulfone, cyclic olefin copolymer, polyethylene terephthalate, or a combination thereof.
Any thermoplastic polymer may have cells comprising interconnected open cells.
Any thermoplastic polymer foam may be a homopolymer.
Any thermoplastic polymer foam may be a copolymer.
Any thermoplastic polymer foam may be a blend of two or more polymers.

The description of embodiments of the disclosure is not intended to be exhaustive or to limit the disclosure to the precise form disclosed. While the specific embodiments of, and examples for, the disclosure are described herein for illustrative purposes, various equivalent modifications are possible within the scope of the disclosure, as those skilled in the relevant art will recognize.

Specific elements of any foregoing embodiments can be combined or substituted for elements in other embodiments. Furthermore, while advantages associated with certain embodiments of the disclosure have been described in the context of these embodiments, other embodiments may also exhibit such advantages, and not all embodiments need necessarily exhibit such advantages to fall within the scope of the disclosure.

The examples described below were conducted in order to create nanofoams from various polymers.

### EXAMPLES

Polycarbonate

Materials

Large MAKROLON® GP polycarbonate sheets from Bayer MaterialScience LLC with a thickness of 0.75 mm were purchased. Sheets were cut into 2.5 cm×2.5 cm samples for sorption and foaming studies. The PC has a density of 1.2 g/cm². Glass transition temperature (T_{g}) was measured to be 147° C. in differential scanning calorimeter (DSC) TA Instruments Q20, with a heating rate of 10° C./min. T_{g} was determined using the half-height method. Medical grade CO₂ (99.9% purity) was purchased from Praxair, Inc.

Sorption

Sorption experiments were conducted by placing samples in a pressure vessel, with the CO₂ pressure inside maintained at 5 MPa. Sorption temperatures varied over a range from −30° C. to 80° C. For sorption experiments above room temperature, a heating jacket wrapped around the pressure vessel and a temperature controller was used to maintain the pressure vessel at a desired temperature. For low temperature sorption conditions (below 0° C.), the pressure vessel was placed in a freezer capable of achieving −30° C. to 0° C. During saturation, samples were periodically taken out from the pressure vessel, and weighed on a Mettler AE240 analytical scale accurate to +/−10 μg. Samples were then promptly put back in the pressure vessel and repressurized. The sorption experiment was continued until no further weight increase was observed in the specimen.

Foaming

Specimens used for foaming studies were first wrapped in a porous paper towel, and then placed in a pressure vessel which was maintained at 5 MPa. Saturation temperatures selected for foaming studies were 40° C., 20 C, 0° C., −20° C., and −30° C. Samples were allowed to absorb CO₂ over a predetermined amount of time (based on the sorption studies). After full saturation, samples were removed from the pressure vessel, and immediately immersed in a hot silicone oil bath (Thermo Haake B5) set at a desired temperature in the range of 50° C. to 130° C. The foaming time used for all samples was 1 minute. After foaming, the sample was immediately quenched in an oil bath which was kept much colder than the foaming oil bath, to stop further foaming.

Characterizations

The excess silicone oil was removed from the surface of the sample before any characterization. The density of each sample was determined according to ASTM D792 using a Mettler AE240 analytical scale. Samples were allowed to desorb for at least one week before density measurement was performed in order to eliminate the effect of residual CO₂.

A representative set of samples were imaged with a scanning electron microscope (SEM) to examine the microstructures produced. All images were taken on a FEI Sirion SEM. Samples were first scored with a razor blade and freeze fractured with liquid nitrogen to expose the cross section. They were then coated with Au/Pd for 90 s at a current of 18 mA. Micrographs were taken at the center of the cross section of the specimen and analyzed using software ImageJ (National Institute of Health, USA). Average cell size was calculated by taking average cell diameters of at least 50 cells in the SEM micrographs. Cell nucleation density was calculated

$${N}_{f} = {( \frac{{nM}^{2}}{A} )}^{\frac{3}{2}}$$

wherein, n is the number of bubbles in the micrograph, A is the area of the micrograph in cm², and M is the magnification factor, then (n/A/M²) gives the area bubble density or the number of bubbles per cm² of the foam. By cubing the line density, the number of bubbles per cm³ of the foam N_{f} can be estimated.

Results and Discussions

Sorption

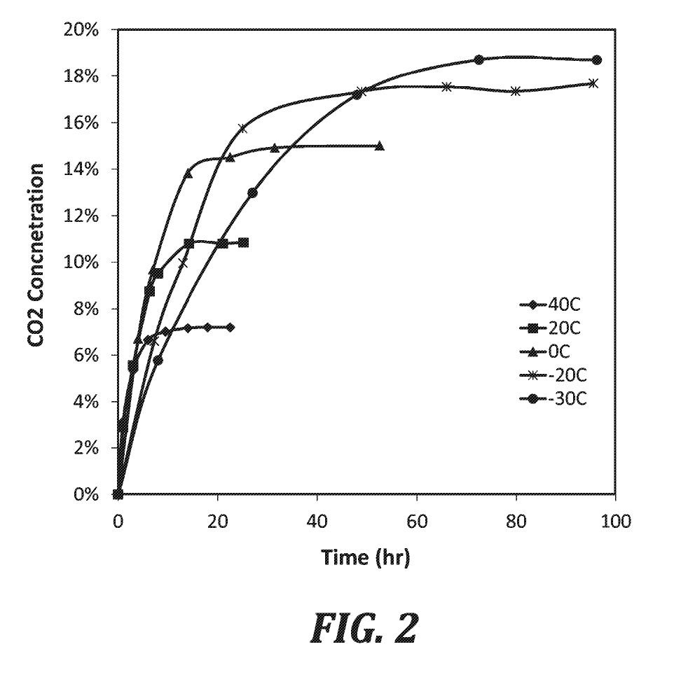

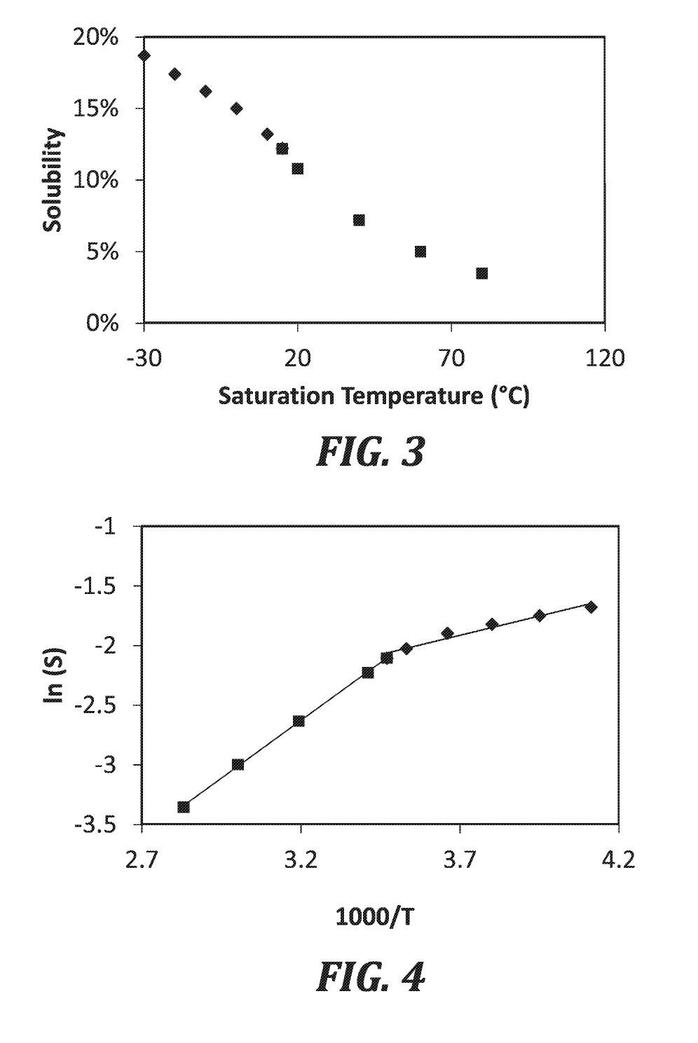

All sorption experiments were conducted at a saturation pressure of 5 MPa. FIG. 2 shows the CO₂ uptake as a function of time at various saturation temperatures. CO₂ uptake is expressed as a percentage of the original polymer mass, e.g., 10% CO₂ concentration means that 10% of the mass of original PC is now absorbed into the PC. The time needed to reach equilibrium concentration (also called solubility) increases as the saturation temperature decreases, from 12 hrs. at 40° C. to 72 hrs. at −30° C. In addition, solubility results for a wider range of temperatures are also summarized in Table 3. To better visualize the solubility trend, the solubility as a function of temperature is plotted in FIG. 3. It can be seen that the temperature markedly affects the solubility of CO₂ in PC. The solubility increases as the saturation temperature decreases in the whole range, approximately 5.3 times increase from 3.5% at 80° C. to 18.7% at −30° C.

TABLE 3
Summary of solubility and diffusivity at various saturation
temperatures.

| Saturation Temperature | | Diffusivity |
|---|---|---|
| (° C.) | Solubility | (cm²/s) |
| 80 | 3.5% | 1.41 × 10⁻⁷ |
| 60 | 5.0% | 8.71 × 10⁻⁸ |
| 40 | 7.2% | 5.66 × 10⁻⁸ |
| 20 | 10.8% | 3.14 × 10⁻⁸ |
| 15 | 12.2% | 2.97 × 10⁻⁸ |
| 10 | 13.2% | 2.72 × 10⁻⁸ |
| 0 | 15.0% | 1.86 × 10⁻⁸ |
| −10 | 16.2% | 1.20 × 10⁻⁸ |
| −20 | 17.4% | 7.31 × 10⁻⁹ |
| −30 | 18.7% | 5.61 × 10⁻⁹ |

The temperature dependence of solubility is typically given by the Arrhenius equation,

$$S = {S}_{0} exp ( - \frac{Δ {H}_{S}}{R T} )$$

where S₀ is the pre-exponential factor, ΔH_{S} is the heat of sorption or enthalpy change upon solution of gas in the polymer, and R is gas constant.

FIG. 4 shows the natural logarithm of solubility as a function of the reciprocal of saturation temperature. Note the X-axis is 1000/T and T is in Kelvin. There are two straight best-fit lines, together with a turning point of 15° C. at which the slope of the two straight lines changes. The 15° C. turning point coincides with the phase change temperature for CO₂ at 5 MPa. Below and above this phase changing temperature, the data follows a linear trend: below 15° C., ΔH_{S} is calculated to be −5.4 kJ/mol; above 15° C., ΔH_{S} is −16.1 kJ/mol. Negative heat of sorption values indicate the exothermic nature of CO₂ sorption in PC.

The difference between these two ΔH_{S} values is 10.7 kJ/mol. This value is essentially the same as the heat of condensation (or heat of vaporization) of CO₂, which is about 11.3 kJ/mol. To explain the result, the absorption of gaseous CO₂ into polymer can be viewed hypothetically as follows: gaseous CO₂ first condenses into CO₂ liquid at a constant temperature, which releases an amount of energy equal to the heat of condensation 11.3 kJ/mol; then 5.4 kJ/mol heat is released from the absorption of CO₂ liquid into polymer; thus, the net heat of sorption of gaseous CO₂ into polymer is −16.8 kJ/mol (very close to experimental data −16.1 kJ/mol).

One of the commonly used methods to determine diffusivity from a sorption plot is the initial slope method, which uses the slope of the initial part of a normalized sorption plot. Using this method, the sorption diffusivities at various saturation temperatures were obtained and summarized in Table 3. The temperature has a profound effect on the diffusivity in the PC-CO₂ system. Diffusivity decreases with the decreasing saturation temperature, nearly two orders of magnitude reduction from 1.41×10⁻⁷ cm²/s at 80° C. down to 5.61×10⁻⁹ cm²/s at −30° C.

The effect of temperature on the diffusivity of gas in polymers was shown to be that of an activated process obeying the Arrhenius relationship:

$$D = {D}_{0} exp ( - \frac{Δ {H}_{D}}{R T} )$$

where D₀ is the pre-exponential factor, ΔH_{D} is the activation energy for diffusion, R is gas constant and T is temperature in K.

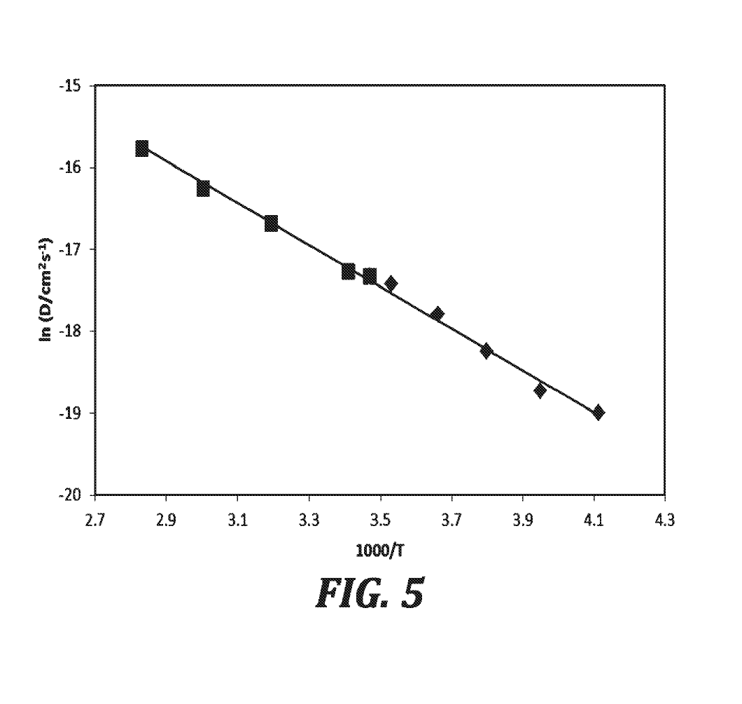

FIG. 5 shows a plot of the natural logarithm of sorption diffusivities in Table 3 as a function of the reciprocal of saturation temperature. The data follows a linear trend and the ΔH_{D} value obtained from the slope is 21.2 kJ/mol for PC-CO₂. In the PC-CO₂ system, a monotonic increase of diffusivity with increasing sorption temperature is observed, suggesting that in the temperature range investigated PC-CO₂ doesn't have the retrograde vitrification behavior observed in PMMA-CO₂. Also, the phase change of CO₂ from gas to liquid, or vice versa, at around 15° C. does not bring any significant change to ΔH_{D}.

Glass Transition Temperature Depression

Absorption of a diluent into a polymer lowers its glass transition temperature, because the diluent molecules increase polymer intermolecular distance, decreasing intermolecular interactions. The weakening of these interactions increases the segmental mobility, which leads to a lower glass transition temperature. CO₂ has very high plasticization effect and can significantly reduce T_{g} to a value much lower than that of the original polymer. This is one of the primary driving mechanisms in solid-state microcellular foaming.

The measurement of T_{g} of polymer-diluent system presents a challenge, since diffusion and cell nucleation must be avoided during heating scan in regular DSC measurement. Previous studies suggested that the minimum foaming temperature and T_{g} of a polymer-diluent system can be considered to be equivalent. Here, the saturated samples were foamed at increasingly higher foaming temperatures while keeping all other processing parameters the same. The minimum foaming temperature was determined as the average value of the two adjacent temperatures at which foaming just did and did not happen. In addition, SEM images of these samples were prepared to confirm the formation of cells. The temperature interval of the two adjacent foaming temperatures was 5° C.

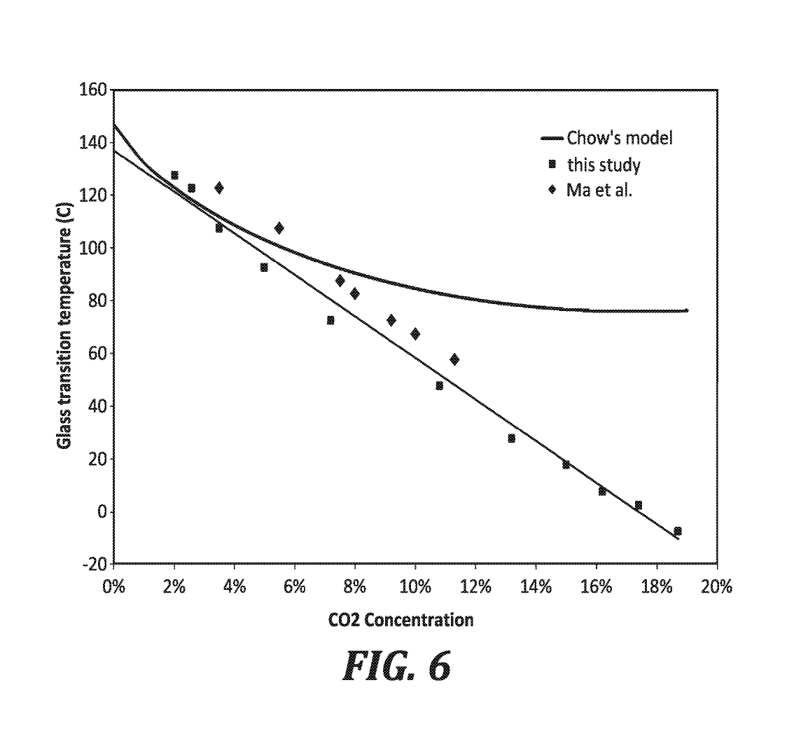

FIG. 6 shows the T_{g} of PC-CO₂ mixture as a function of CO₂ solubility. The CO₂ absorbed in the PC causes a significant T_{g} reduction; the T_{g} decreases down to −7.5° C. at 18.7% CO₂. In addition, a linear relationship between the T_{g} and solubility can be observed, and a 1% solubility increase results in an approximately 8° C. decrease in T_{g}. The intercept of a least-squares fit with y-axis (namely, when solubility is 0) corresponds to 137° C., which is close to the T_{g} (147° C.) of unsaturated PC obtained by DSC. The T_{g} of PC-CO₂ has been reported up to 12% solubility, and the reported data are included in the graph as a comparison. The reported T_{g} from his study is higher than the experimental data at similar solubilities. This could be due to differences in the PC used. Nevertheless, both studies show a linear relationship and the best-fit lines are essentially parallel to each other. Similar linear relationships between T_{g} and solubility have also been observed in PEI, PES, PSU, and COC.

In a previous study, Chow developed a model to predict the T_{g} of a polymer/diluent mixture using statistical mechanics. The comparison between predicted values from Chow's model and experimental data is shown in FIG. 6. Parameters used are ΔCₚ=0.245 J K⁻¹ g⁻¹ and z=2 for PC.

Foaming

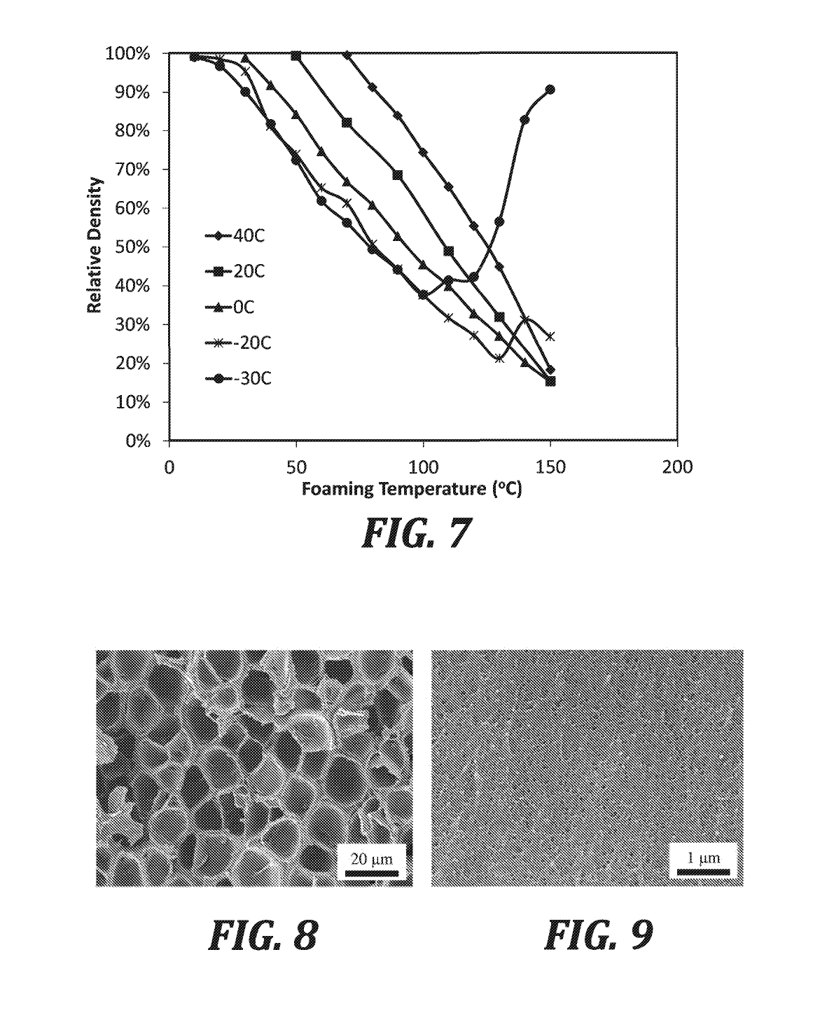

The relative density of a foam is defined as the density of a foamed sample divided by the density of the unsaturated polymer. FIG. 7 shows the relative density of foamed samples as a function of foaming temperatures. These samples were initially saturated at different temperatures, ranging from −30° C. to 40° C. Increasing foaming temperature reduces the relative density of foamed PC due to enhanced cell nucleation and cell growth. Relative densities of as low as 15% in 40° C. saturated samples and 38% in −30° C. saturated samples can be produced. The relative density-foaming temperature plot provides guidelines for creating foams of desired densities. For 0° C., 20° C., and 40° C. saturation temperatures, relative densities decrease steadily as the foaming temperature increases in the range (up to 150° C.) investigated. The trend is different for much higher gas concentration cases. For the −20° C. case, relative densities firstly decrease to a minimum at a 130° C. foaming condition, and then increase at higher temperatures.

Similarly, for the −30° C. case, relative densities firstly decrease to around 40% in the range of 100° C.-120° C., and then rapidly increase at successively higher temperatures. The reason for the increase of relative densities at higher temperatures is that at such high temperatures, the very low viscosity and fast gas diffusion caused bubble coalescence and/or collapse, which was manifested in blistering and shrinkage of the sample during foaming.

In addition, drawing a horizontal line in the relative density plot, different processing conditions to produce foams of the same relative density can be found. These different conditions can produce vastly different cellular morphologies. For example, from Table 1, sample #6 and sample #23 have a similar density, but sample #6 has a cell size of 12 μm (microcellular foam) and sample #23 has a cell size of 28 nm (nanocellular foam). Cell size of the microcellular foam is 400 times larger than that of the nanofoam. Micrographs of these two samples are shown in FIGS. 8 and 9. Sample #6 (FIG. 8) was saturated at 40° C. and then foamed 130° C., whereas sample #23 (FIG. 9) was saturated −30° C. and then foamed 90° C.

Cellular Morphology

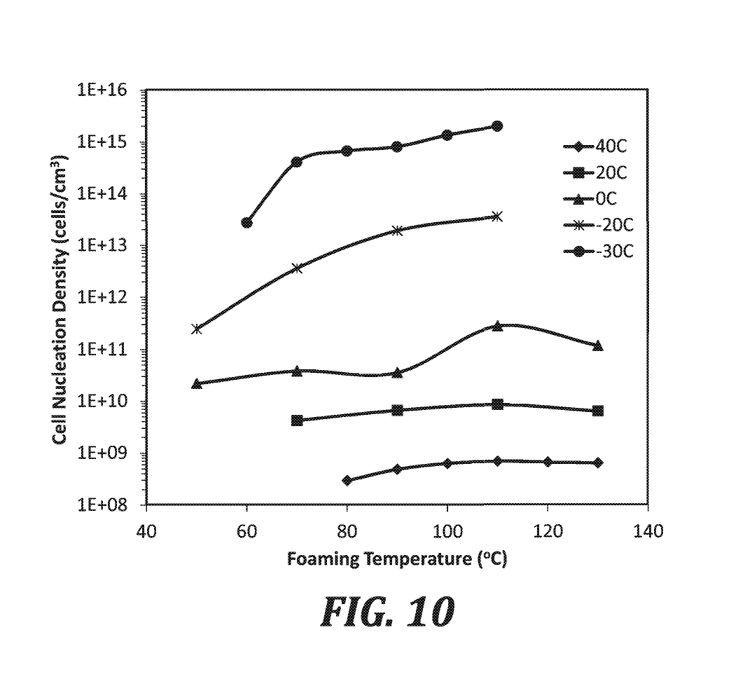

Representative samples were imaged by SEM to characterize the cellular structure resulting from various processing conditions. Main cellular structure characteristics investigated were average cell size and cell nucleation density. Table 1 above summarizes the processing conditions and characteristics of the foams selected for cellular morphology investigation. The relative density, cell nucleation density and average cell size are listed. FIG. 10 shows cell nucleation density as a function of foaming temperature for foamed samples saturated at different temperatures. A lower saturation temperature (thus higher CO₂ concentration from Table 3) results in a higher cell nucleation density. For example, the cell nucleation densities have seven orders of magnitude increase from about 10⁸ cells/cm³ for 40° C. samples (7.2% CO₂ concentration) to around 10¹⁵ cells/cm³ for −30° C. samples (18.7% CO₂ concentration).

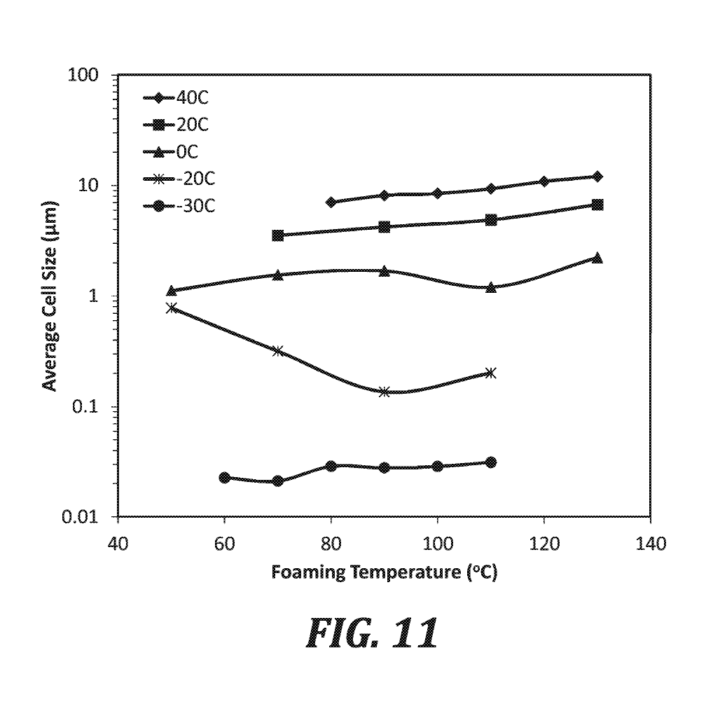

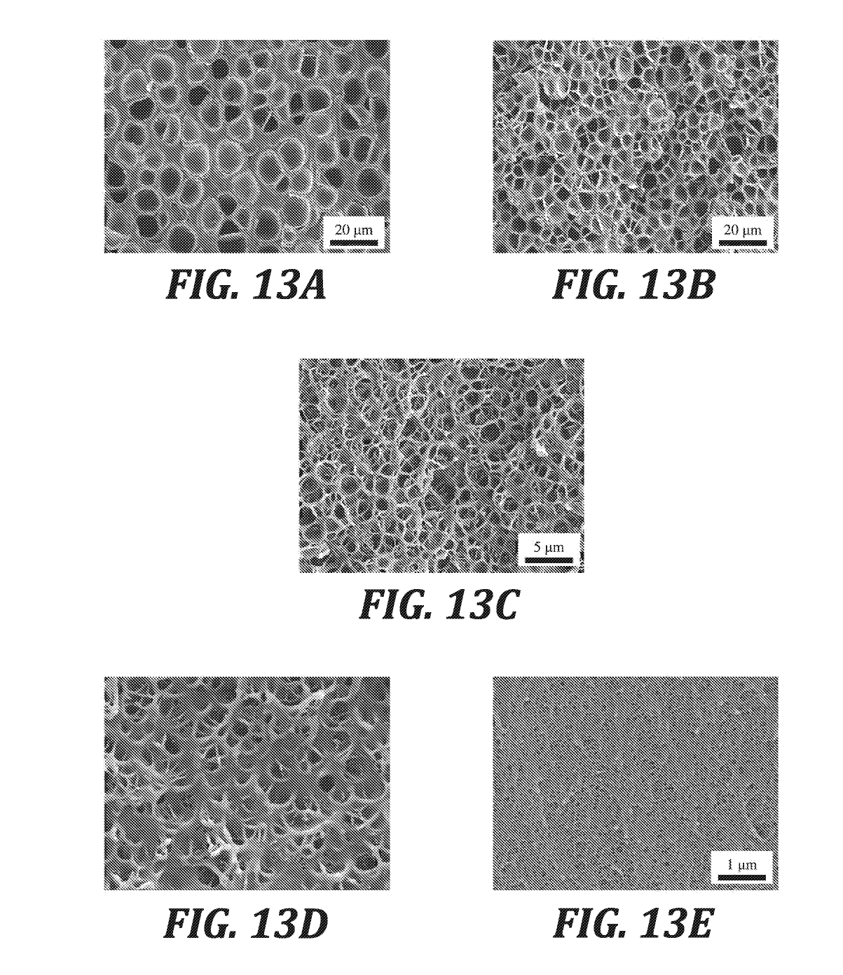

FIG. 11 shows average cell size as a function of foaming temperature for foamed samples saturated at different temperatures. For 0° C., 20° C., and 40° C. saturated samples, cell sizes are in the range of 1-10 μm. These are typical microcellular foams. However, for −20° C. and −30° C. saturated samples, cell sizes fall well below 1 μm into the nanocellular region. For −30° C. samples, cell sizes are only about 20-30 nm. FIGS. 12 and FIG. 13 show SEM images of samples foamed at 90° C. and 110° C., respectively. The average cell size in FIGS. 12(a), (b), (c), (d), and (e) is 8 μm, 4 μm, 1.7 μm, 136 nm, and 28 nm, respectively. The average cell size in FIGS. 13(a), (b), (c), (d), and (e) is 9 μm, 5 μm, 1.2 μm, 201 nm, and 31 nm, respectively.

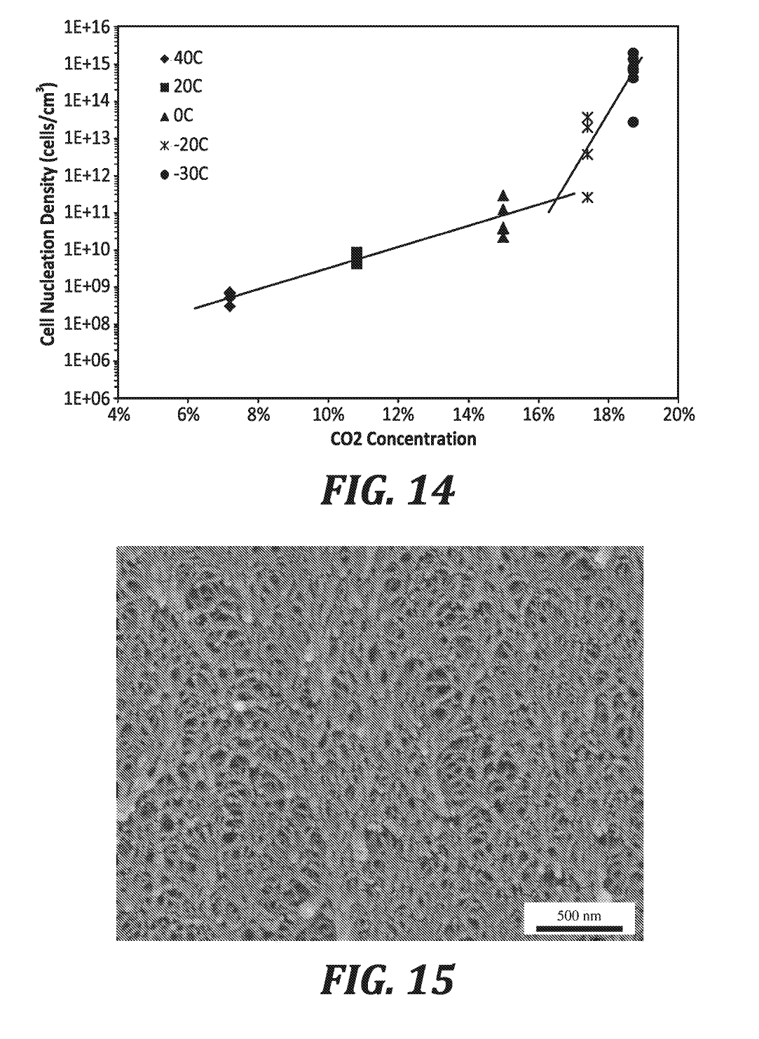

To better visualize how cell nucleation densities evolve as CO₂ concentration increases, the cell nucleation densities at various saturation temperatures as a function of CO₂ concentration is plotted in FIG. 14. For 7%-15% CO₂ concentration range, cell nucleation density exponentially increases with CO₂ concentration; foamed samples show microcellular morphology. However, above 15% and up to 18.7%, the exponential increase of cell nucleation density is more significant (as can be seen from the much larger slope of the straight line), resulting in nanocellular morphology. In this range, a 1%-2% increase in CO₂ concentration brings about two orders of magnitude increase in cell nucleation density, compared to only one order of magnitude increase in cell nucleation density for a 3%-4% increase in CO₂ concentration when the CO₂ concentration is below 15%. Therefore, there exists a CO₂ concentration window, at which microcellular foams turns into nanocellullar foam, and this window for PC is between 15% and 17.4%.

One hypothesis for the physical mechanism for the transition from microcellular foams to nanocellular foams at a CO₂ concentration is based on the homogeneous nucleation theory, shown as follows:

$${N}_{0} = {C}_{0} {f}_{0} exp ( - \frac{Δ {G}_{crit}}{k T} )$$

$$Δ {G}_{crit} = \frac{16 π {σ}^{3}}{3 Δ {P}^{2} }$$

where N₀ is the nucleation rate, ΔG_{crit} is the activation energy of critical nucleus formation, C₀ is the concentration of gas molecules, f₀ is the frequency factor of gas molecules joining a nucleus, k is the Boltzmann constant, T is the absolute temperature, σ is the surface energy at the polymer-cell interface, and ΔP is saturation pressure.

According to this theory, a cluster of CO₂ molecules need to overcome an activation energy barrier ΔG_{crit} in order to form a stable nucleus. When the nucleus exceeds a critical size, spontaneous cell growth will occur. Generally, a higher CO₂ concentration increases plasticization of the polymer, lower its viscosity and surface energy σ, and eventually reduces activation energy ΔG_{crit} needed for nucleation. It might be that around the certain CO₂ concentration, a larger drop of surface energy σ occurs (than the drop of σ when CO₂ concentration is below a certain concentration), probably due to an enhanced interaction between PC and CO₂, and since ΔG_{crit} is a third-power function of σ, it reduces much more dramatically. This significant reduction in activation energy ΔG_{crit} results in a much larger nucleation rate N₀. Therefore, a rapid increase in cell nucleation density occurs at the preferred concentration window.

In addition, for the nanocellular foams, samples with relatively lower densities seem to have interconnectivity based on SEM micrographs. FIG. 15 shows the magnified center region of FIG. 13(e). Sample was prepared by saturating at −30° C. and then foamed at 110° C. The relative density is 41.4%. The visible underlying struts indicate some interconnectivity in the structure.

In order to verify the porous nature of the foamed samples, a simple dye test was performed. A porous sample has pores inside interconnected, which allow the dye to penetrate from the surface to deep inside. A sample was first freeze fractured in liquid nitrogen to expose a clean cross section. Then dye/isopropanol solution was applied to the surface of this cross section for 10 minutes. Afterwards, the sample was freeze fractured again to expose the depth direction perpendicular to the previous cross section. Penetration of dye solution into the sample can be observed from the depth direction. For −30° C. saturation samples, no die penetration was observed in samples foamed up to 100° C.; however, 110° C. and 120° C. foamed samples, die penetration was observed. These observations indicate that sufficiently high temperatures are needed to create nanoporous structures. The open nanoporous structure combined with the excellent mechanical and thermal properties renders the nanoporous PC as a novel material for high performance filtration, gas separation, and battery separators application.

The phenomenon of changing from closed cell structure to open cell structure at higher foaming temperatures is interesting. From FIG. 6, the T_{g} or minimum foaming temperature was −7.5° C. for −30° C. saturated PC sample. It's not until when the foaming temperature is 110° C. that open cellular morphology was observed. The large temperature difference (>120° C.) between T_{g} of saturated sample and foaming temperature results in a significant thermal instability of PC-CO₂ mixture and a large reduction in polymer viscosity. Two hypotheses are proposed to explain the morphology change. One hypothesis is based on the cell wall thinning At high foaming temperature, samples have relatively low viscosity and thus undergo larger expansion, resulting in lower densities. At high expansion ratio, cell walls become very thin and cells start to impinge each other. Eventually, at a sufficiently large expansion ratio, cell walls become so thin that they cannot sustain the stretching stress from the cell growth expansion and thus break down. As a result, cells become interconnected. Another possible mechanism is the spinodal decomposition. As opposed to classical nucleation theory where discrete nucleation sites exist, in spinodal decomposition, the homogenous binary mixture separates into two uniform and interconnected phases: polymer rich phase and CO₂ rich phase. This phase separation results in a bicontinuous (or co-continuous) structure. These hypotheses have yet to be tested.

Conclusions

The solid-state foaming process offers great control over the final cell morphology and density of foams by varying processing parameters, such as saturation temperature, saturation pressure, foaming temperature, and etc. In this study, the saturation pressure is maintained at 5 MPa to investigate the effect of saturation temperature (−30° C. up to 80° C.) on CO₂ solubility, diffusivity, cellular structure and foam density in the PC-CO₂ system.

Saturation temperature has significant effects on both the solubility and diffusivity. Solubility increases with decreasing saturation temperature, approximately 5.3 times increase from 3.5% at 80° C. to 18.7% at −30° C. A change of heat of sorption has been found at around 15° C., the vaporization temperature at 5 MPa for CO₂. The change of heat of sorption matches with heat of vaporization due to the vapor-liquid phase change. When CO₂ is either gas or liquid, solubility and temperature follows the Arrhenius relationship. Diffusivity decreases with decreasing saturation temperature, nearly two orders of magnitude reduction from 1.41×10⁻⁷ cm²/s at 80° C. down to 5.61×10⁻⁹ cm²/s at −30° C. In contrast with solubility, diffusivity follows the Arrhenius equation with respect to temperature in the whole range (both gaseous and liquid CO₂ regions) with an activation energy of 21.2 kJ/mol.

Dissolution of CO₂ into PC dramatically plasticizes the polymer: incorporation of 18.7% CO₂ in PC decreases the T_{g} from 147° C. down to −7.5° C. The minimum foaming temperature, or equivalently effective T_{g} of mixture, shows a linear relationship with CO₂ concentration in the PC-CO₂.

In addition, CO₂ concentration greatly influences cellular structure. As CO₂ concentration increases, cell nucleation densities increase and cell sizes reduce across the whole concentration range investigated. More importantly, a preferred CO₂ concentration occurs between 15% and 17.4%. Within this concentration window, cell nucleation density increases much more rapidly with a small increase in CO₂ concentration, and consequently microcellular foams turn into nanocellular foams. This concentration window is polymer dependent. Also, at the high CO₂ concentration (18.7%) and a higher foaming temperature (>100° C.), closed nanocellular foams become bicontinuous open nanoporous foams with the characteristic cell size around 30 nm. This open nanoporous structure combined with the excellent mechanical and thermal properties renders the nanoporous PC as a novel material for high performance filtration, gas separation, and battery separators application.

Homogenous PC nanofoams with cell size in the range of 20-30 nm, cell nucleation density over 10¹⁵ cells/cm³, and relative density as low as 38% have been obtained. Creation of nanofoams using the low temperature liquid carbon dioxide saturation has advantages over existing methods, which usually involves complicated synthesis process and are typically only applicable to copolymers or blends, not homopolymers.

PMMA

Materials

Acrylite® FF PMMA sheets manufactured by CYRO Industries (New Jersey, USA) with a thickness of 1.5 mm were purchased. Sheets were cut into 2.5 cm×2.5 cm samples using a band saw. The PMMA has a density of 1.19 g/cm. Glass transition temperature (T_{g}) was measured to be 103° C. in differential scanning calorimeter (DSC) TA Instruments Q20, with a heating rate of 10° C./min. T_{g} was determined using the half-height method. Medical grade CO₂ (99.9% purity) was purchased from Praxair, Inc.

Sorption

Sorption experiments were conducted by placing samples in a pressure vessel, with the CO₂ pressure inside maintained at 5 MPa with an accuracy of +/−0.1 MPa. Sorption temperatures varied over a wide range from −30° C. to 100° C. For sorption experiments above room temperature, a heating jacket wrapped around the pressure vessel and a temperature controller was used to maintain the pressure vessel at a desired temperature. For low temperature sorption conditions (below 0° C.), the pressure vessel was placed in a freezer capable of achieving −30° C. to 0° C. During saturation, samples were periodically taken out from the pressure vessel, and weighed on a Mettler AE240 analytical scale accurate to +/−10 μg. Samples were then promptly put back to the pressure vessel and repressurized. The sorption experiment continued until no further weight increase was observed in the specimen.

Foaming

Specimens used for foaming studies were first wrapped in porous paper towel, and then placed in a pressure vessel which was maintained at 5 MPa. Saturation temperatures selected for foaming studies were 80° C., 40° C., 20° C., 0° C., −10° C., −20° C., and −30° C. Samples were allowed to absorb CO₂ over a predetermined amount of time (based on the sorption studies). After full saturation, samples were removed from the pressure vessel, and immediately immersed in a hot silicone oil bath (Thermo Haake B5) set at a desired temperature in the range of 0° C.-120° C. The foaming time used for all samples was 1 minute. After foaming, the sample was immediately quenched in an oil bath which was kept much colder than the foaming oil bath, to stop further foaming.

Characterizations

The excess silicone oil was removed from the surface of the sample before any characterization. The density of each sample was determined according to ASTM D792 using a Mettler AE240 analytical scale. Samples were allowed to desorb for at least one week before density measurement was performed in order to eliminate the effect of residual CO₂.

A representative set of samples were imaged with a scanning electron microscope (SEM) to examine the microstructures produced. All images were taken on a FEI Sirion SEM. Samples were first scored with a razor blade and freeze fractured with liquid nitrogen to expose the cross section. They were then coated with Au/Pd for 90 s. Micrographs were taken at the center of the cross section of the specimen and analyzed using software ImageJ (National Institute of Health, USA). Average cell size was calculated by taking average cell diameters of at least 50 cells in the SEM micrographs. Cell nucleation density was calculated using a procedure described above.

Results and Discussions

Sorption

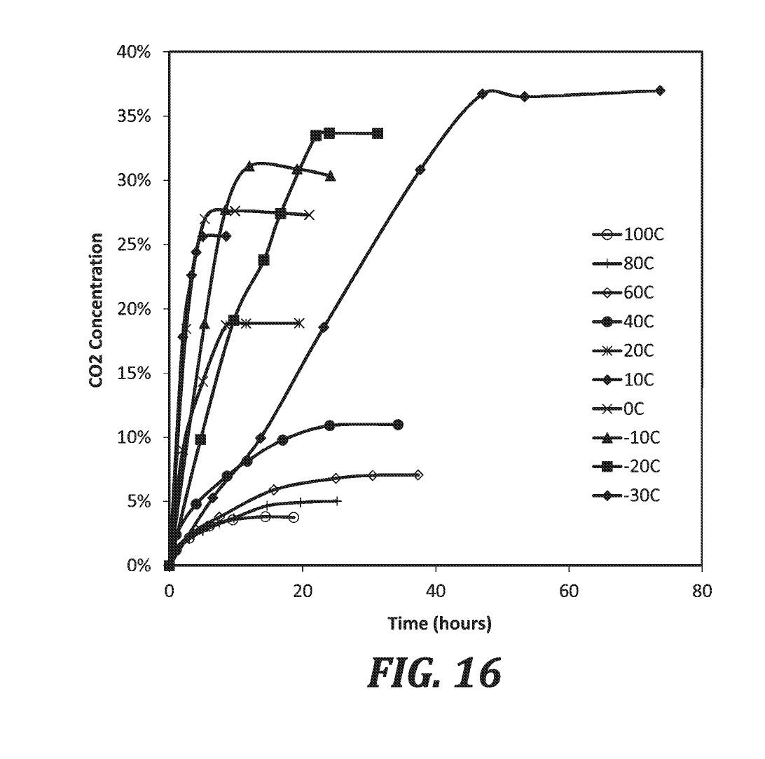

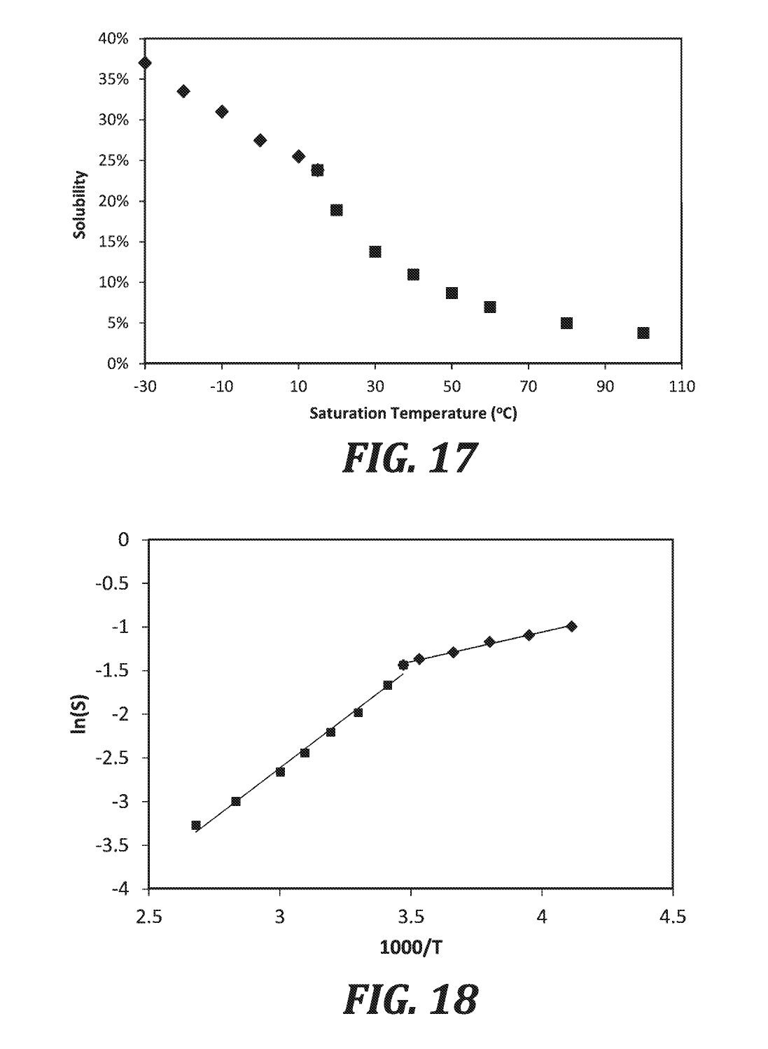

FIG. 16 shows the CO₂ uptake in PMMA as a function of time at various saturation temperatures, ranging from −30° C. to 100° C. The saturation pressure was fixed at 5 MPa. CO₂ concentration is expressed as a percentage of the original polymer mass, e.g., 10% CO₂ concentration means that 10% of the mass of original PMMA is now absorbed into the PMMA. From FIG. 16, the time needed to reach equilibrium is different for different saturation temperatures, with 0° C. taking the shortest (˜7 hrs.) and −30° C. the longest (˜45 hrs.). Sorption diffusivity, which will be discussed later, can be used to characterize how fast the sorption takes place. Also, the equilibrium CO₂ concentration (or solubility) is very different at different saturation temperatures and increases with decreasing temperature. For example, by decreasing temperature from 100° C. to −30° C., the solubility increases from 3.8% to 37%, a ten-fold increase. Solubility results are summarized in Table 4. To better visualize the solubility trend, the solubility as a function of temperature is plotted in FIG. 17.

TABLE 4
Summary of solubility and diffusivity at various saturation
temperatures.

| Saturation | | |
|---|---|---|
| temperature (° C.) | Solubility | Diffusivity (cm²/s) |
| 100 | 3.8% | 1.31 × 10⁻⁷ |
| 80 | 5.0% | 6.98 × 10⁻⁸ |
| 60 | 7.0% | 5.30 × 10⁻⁸ |
| 50 | 8.7% | 4.88 × 10⁻⁸ |
| 40 | 11.0% | 5.57 × 10⁻⁸ |
| 30 | 13.8% | 6.54 × 10⁻⁸ |
| 20 | 18.9% | 1.39 × 10⁻⁷ |
| 15 | 23.8% | 2.52 × 10⁻⁷ |
| 10 | 25.5% | 2.82 × 10⁻⁷ |
| 0 | 27.5% | 2.14 × 10⁻⁷ |
| −10 | 31.0% | 1.03 × 10⁻⁷ |
| −20 | 33.5% | 4.74 × 10⁻⁸ |
| −30 | 37.0% | 2.38 × 10⁻⁸ |

The temperature dependence of solubility is typically given by Arrhenius equation,

$$S = {S}_{0} exp ( - \frac{Δ {H}_{S}}{R T} ) \qquad ( 1 )$$

where S₀ is the pre-exponential factor, ΔH_{S} is the heat of sorption or enthalpy change upon solution of gas in the polymer, and R is gas constant.

In FIG. 18, the natural logarithm of solubility as a function of the reciprocal of saturation temperature is plotted. Note the X-axis is 1000/T and T is in Kelvin. There are two straight best-fit lines, together with a turning point of 15° C. at which the slope of the two straight lines changes. The 15° C. turning point coincides with the phase change temperature for CO₂ at 5 MPa. Below and above this phase changing temperature, the data follows a linear trend: below 15° C., ΔH_{S} is calculated to be −5.6 kJ/mol; above 15° C., ΔH_{S} is −19 kJ/mol. Negative heat of sorption values indicate the exothermic nature of CO₂ sorption in PMMA. The difference between these two ΔH_{S} values is 13.4 kJ/mol. This value is close to the heat of condensation (or heat of vaporization) of CO₂, which is about 11.3 kJ/mol.

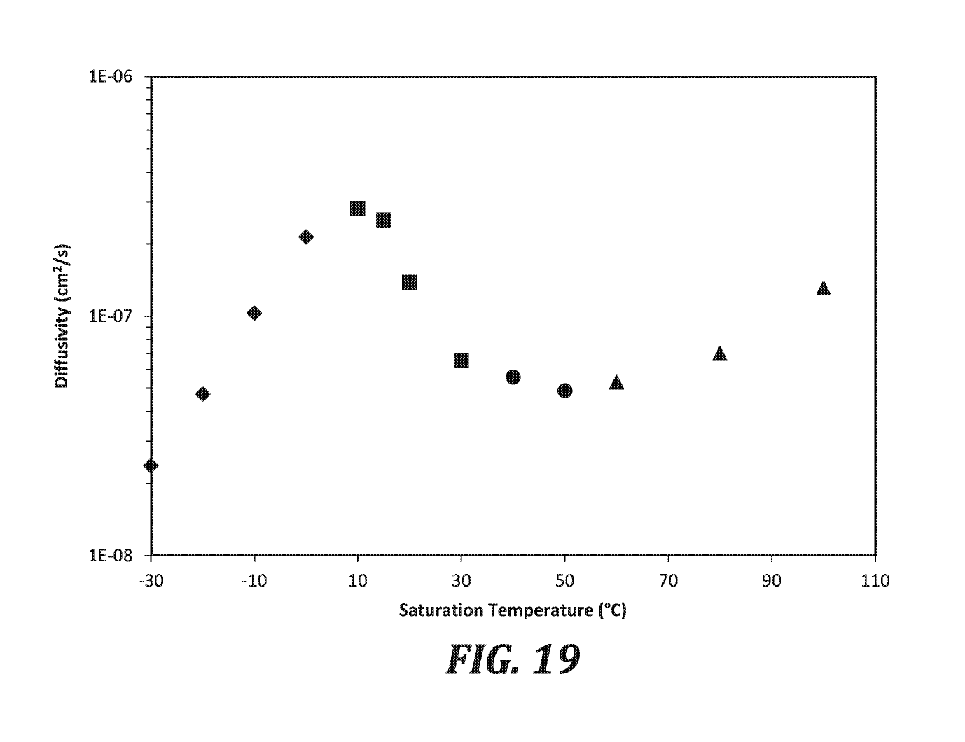

One of the commonly used methods to determine diffusivity from a sorption plot is the initial slope method, which uses the slope of the initial part of a normalized sorption plot. Using this method, the sorption diffusivities at various saturation temperatures are obtained and summarized in Table 4. Also, the diffusivity data in FIG. 19 is plotted. The temperature has a profound effect on the diffusivity of PMMA-CO₂ system. An order of magnitude variation can be seen, with the lowest diffusivity 2.38×10⁻⁸ cm²/s at −30° C. and the highest 2.82×10⁻⁷ cm²/s at 0° C. From the figure, the diffusivity doesn't monotonically increase with increasing temperature across the entire temperature range, but instead, diffusivity increases with temperature in the range of −30° C.-10° C., decreases in the range of 10° C.-50° C., and increases again in the range 50° C.-100° C. This is in contrast to most polymer-gas systems.

The effect of temperature on the diffusivity of gas in polymers is that of an activated process obeying the Arrhenius relationship:

$$D = {D}_{0} exp ( - \frac{Δ {H}_{D}}{R T} )$$

where D₀ is the pre-exponential factor, ΔH_{D} is the activation energy for diffusion, R is gas constant and T is temperature in K.

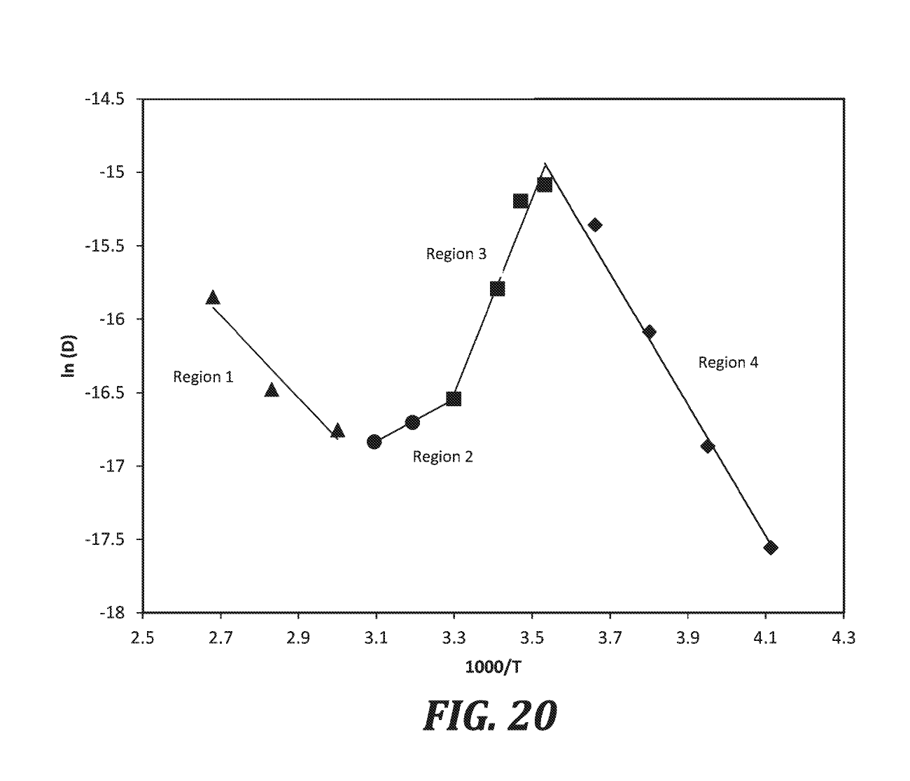

In FIG. 20, the natural logarithm of sorption diffusivities in Table 4 as a function of the reciprocal of saturation temperature are plotted. Four distinct regions are identified. Within each region, a linear trend can be observed. Temperatures range, activation energy for diffusion and physical state of PMMA-CO₂ in each region are summarized in Table 5. In region 2 and region 3, a decrease in temperature actually causes an increase in diffusivity, and activation energies for both regions are negative. When temperature decreases, the solubility rapidly increases, which induces significant plasticization. This large extent of plasticization enables a faster diffusion.

Also, there are three physical state transitions of PMMA-CO₂, as shown in Table 5. The retrograde behavior of a PMMA-CO₂ system was reported. It was reported that for PMMA-CO₂ at 5 MPa, the rubber-to-glass transition temperature were at between 50-60° C. and the glass-to-rubber transition (retrograde vitrification) temperature between 20-30° C. Results on these two transitions temperatures match well, with the rubber-to-glass transition (from region 1 to region 2) temperature between 50-60° C. and the glass-to-rubber transition (from region 2 to region 3) temperature at 30° C. In addition to these two transitions, another rubber-to-glass transition (from region 3 to region 4) at around 10° C. is seen. The slower solubility increase below 15° C. due to phase change is believed to cause this third physical state transition of PMMA-CO₂.

TABLE 5
Characteristics of the four distinct diffusion regions.

| | | | Physical state of |
|---|---|---|---|
| | Temperature range | ΔH_{D} (kJ/mol) | PMMA-CO₂ |
| Region 1 | 60° C.-100° C. | 23.2 | Rubbery |
| Region 2 | 30° C.-50° C. | −11.9 | Glassy |
| Region 3 | 10° C.-30° C. | −55.2 | Rubbery |
| Region 4 | −30° C.-10° C. | 37.1 | Glassy |

Glass Transition Temperature Depression

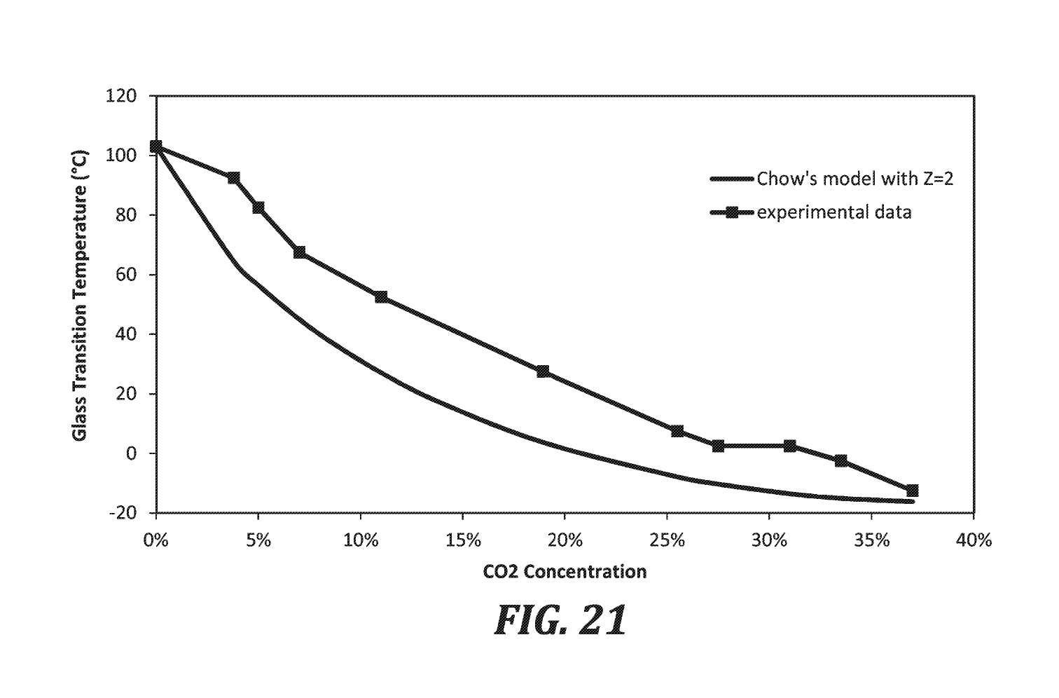

Previous studies suggested that the minimum foaming temperature and T_{g} of polymer-diluent system can be considered to be equivalent. In this study, saturated samples were foamed at increasingly higher foaming temperatures while keeping all other processing parameters the same. The minimum foaming temperature was determined as the average value of the two adjacent temperature at which foaming just did and did not happen. In addition, SEM images of these samples were prepared to confirm the formation of cells. The temperature interval of the two adjacent foaming temperatures was 5° C. FIG. 21 shows the glass transition temperature (T_{g}) of PMMA-CO₂ as a function of CO₂ concentration. It's evident that the absorbed CO₂ greatly depresses T_{g} of PMMA. It reduces from 103° C. to −12.5° C. when 37% CO₂ is incorporated into PMMA. Also shown in FIG. 21 is Chow's model with z=2. The model can predict the general decreasing trend of T_{g}; however, it predicts a T_{g} value lower than the experimental data consistently for all the CO₂ concentrations.

Foaming

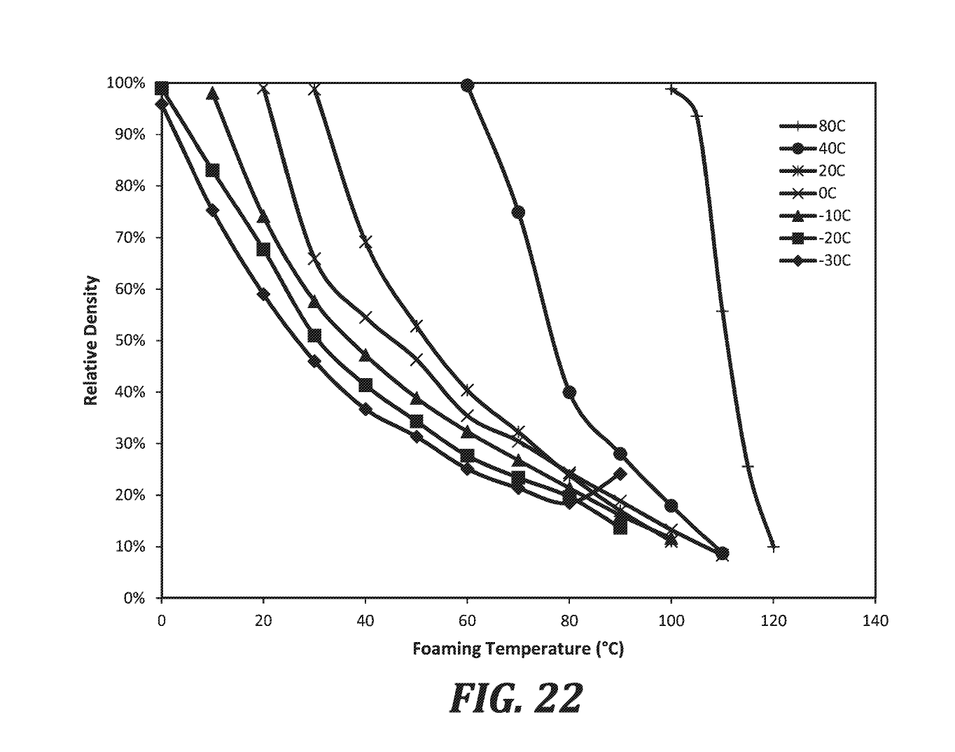

Samples were initially saturated at different saturation temperatures, ranging from −30° C. to 80° C., and then foamed in a range of temperatures. FIG. 22 shows the relative density of foamed samples as a function of foaming temperatures. Table 2 above summarizes the processing conditions and foam characteristics, including relative density.

Although the general decreasing tread with increasing foaming temperature holds for samples saturated at various temperatures, the rate of density reduction is different. The reduction rate is higher for samples saturated at higher temperatures, which has lower CO₂ concentration. It only needs 20° C. increase in foaming temperature for samples saturated at 80° C. in order to reduce its relative density from 100% to about 15%; however, it needs 90° C. for −20° C. saturated samples to achieve roughly the same amount of density reduction.

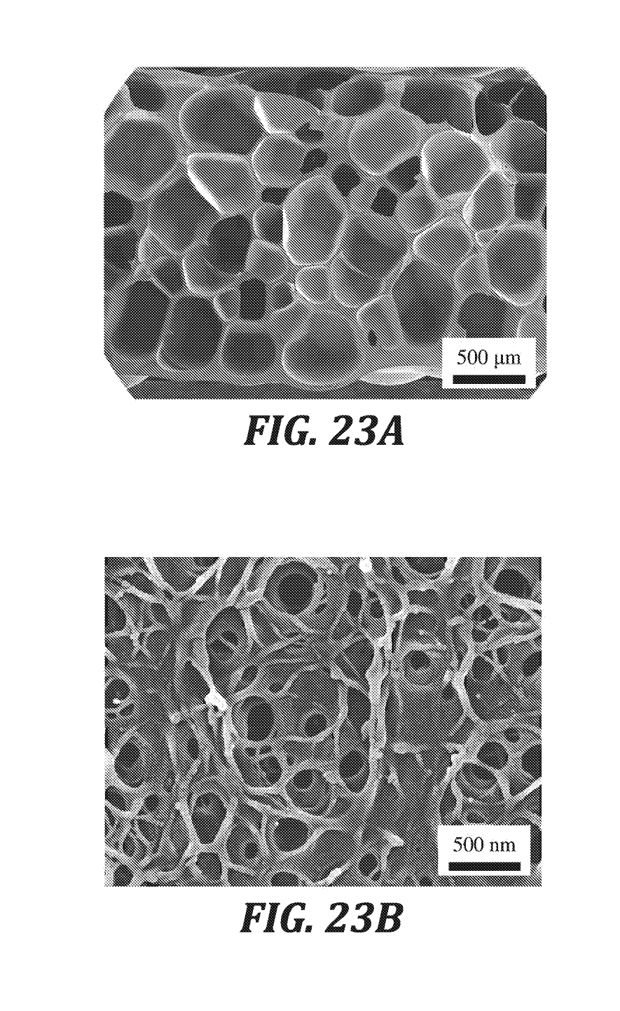

As will be mentioned later, −10° C., −20° C. and −30° C. saturated samples generate nanofoams. Thus, nanofoams with relative density as low as 14% can be achieved. By drawing a horizontal line in the relative density plot, different processing conditions to produce foams of the same relative density can be found. These different conditions can produce vastly different cellular morphologies. For example, FIGS. 23(a) and (b) show two samples of similar density, but cell size is more than 3000 times different.

Cellular Morphology

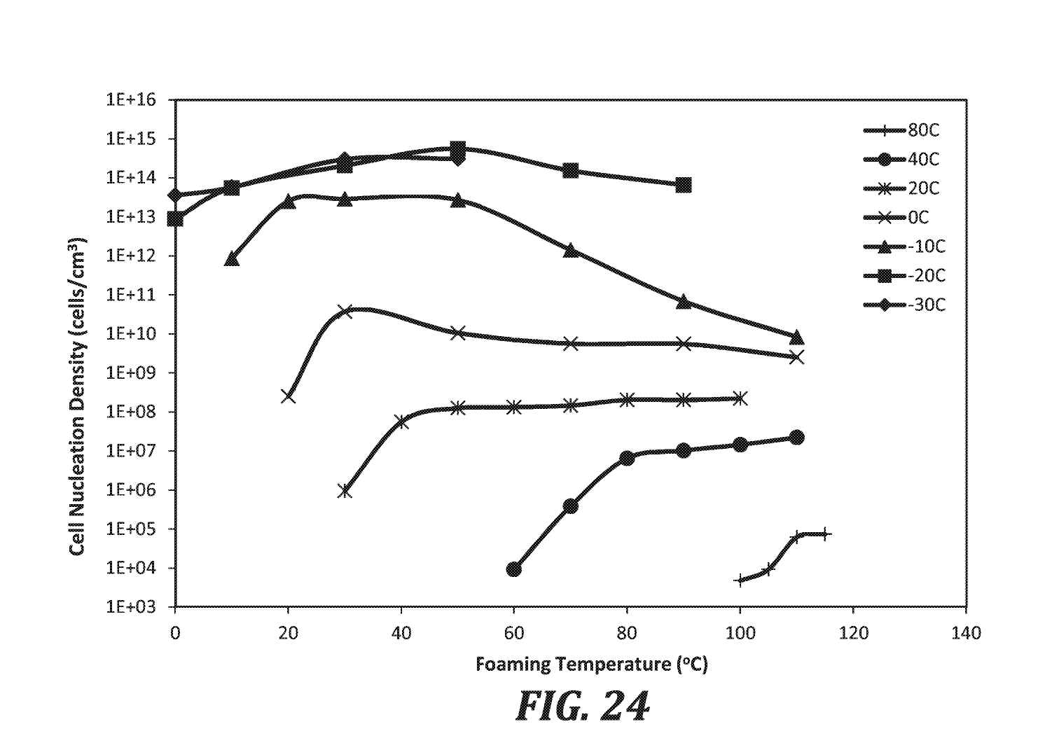

Representative samples were imaged by SEM to characterize the cellular structure resulting from various processing conditions. Main cellular structure characteristics investigated are average cell size and cell nucleation density. FIG. 24 shows cell nucleation density as a function of foaming temperature for foamed samples saturated at different temperatures. A lower saturation temperature (thus higher CO₂ concentration from FIG. 17) results in a higher cell nucleation density. For example, the cell nucleation densities have 10 orders of magnitude increase from about 10⁴ cells/cm³ for 80° C. samples to around 10¹⁴ cells/cm³ for −30° C. samples.

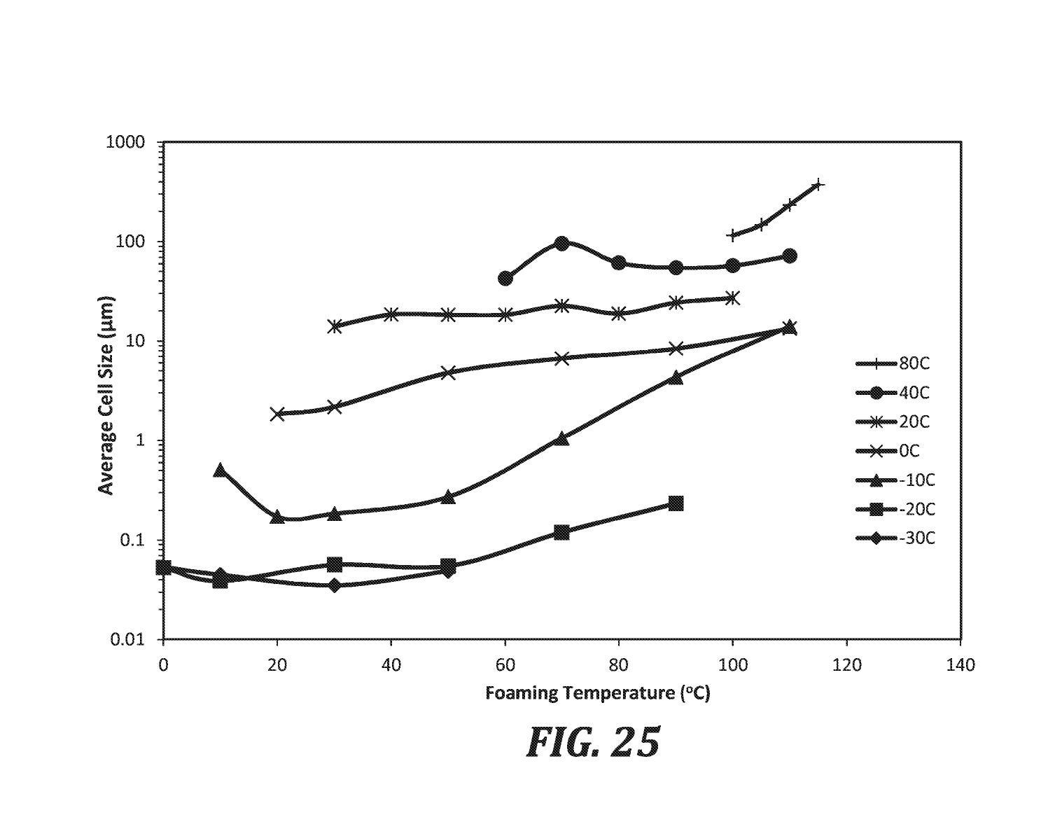

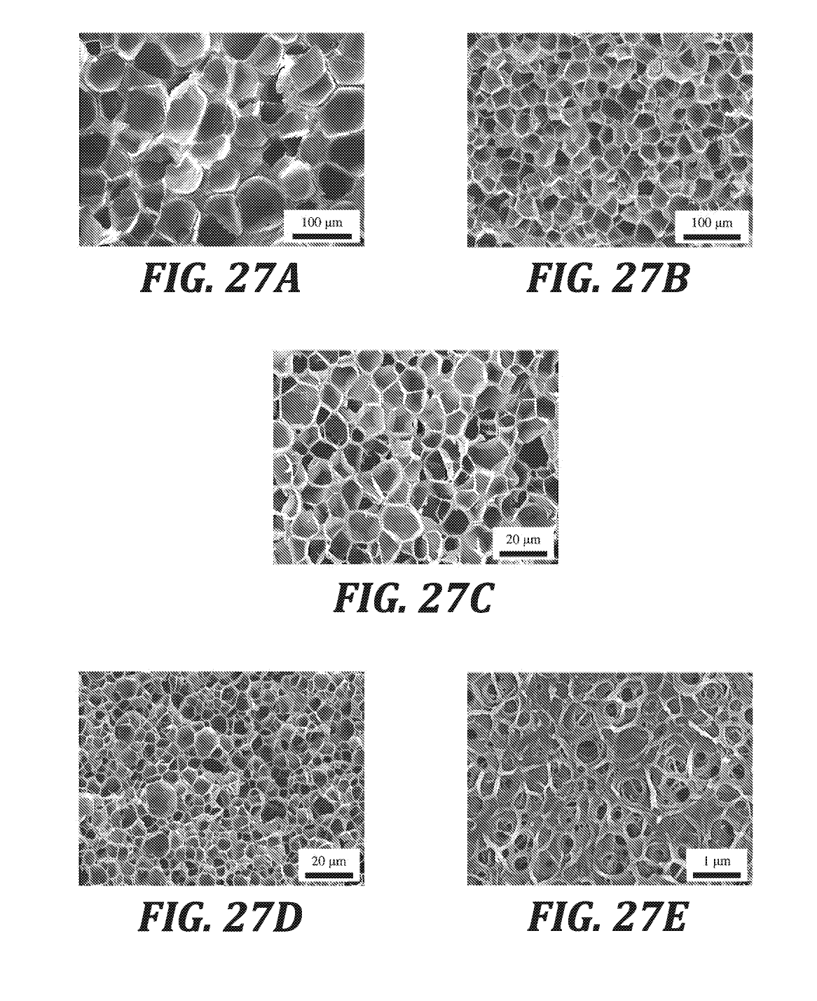

FIG. 25 shows average cell size as a function of foaming temperature for foamed samples saturated at different temperatures. For 80° C., 40° C., 20° C. and 0° C. saturated samples, cell sizes are above 1 μm. These are typical microcellular foams. However, for −10° C., −20° C. and −30° C. saturated samples, cell sizes fall well below 1 μm into the nanocellular region. For −20° C. and −30° C. saturated samples, cell sizes are only about 40 nm. FIGS. 26(a)-(e) show SEM images of samples saturated at different temperatures and foamed at a foaming temperature of 50° C. FIGS. 27(a)-(e) show SEM images of samples saturated at different temperatures and foamed at a foaming temperature of 90° C.

Nanoporous Structures

For samples with very high CO2 concentration (33.5% at −20° C. saturation and 37% at −30° C.), foaming at higher temperatures (above 30° C.) resulted in porous structures. Samples #33, #34, #35, #36, #39, #40 all show bicontinuous nanoporous structures. FIG. 28 shows such an example. The underlying structures can be seen from the cross section.

Worm-Like Nanostructures

Foaming at 70° C. and above, −30° C. saturated samples (sample #41 and #42) showed uniform worm-like nanostructures. FIGS. 29(a) and (b) show these interesting structures. The width/diameter of the “worms” is about 100 nm. The “worms” seem to be tightly packed together, with some cavities between. However, the relative density is very low, about 21.3%. This lower relative density is unlikely to be justified by the volume of cavities between “worms” shown in the micrographs. Thus, the “worms” may be porous themselves, with pores too small to be detected by the SEM.

Macro-Micro-Nano Transitions

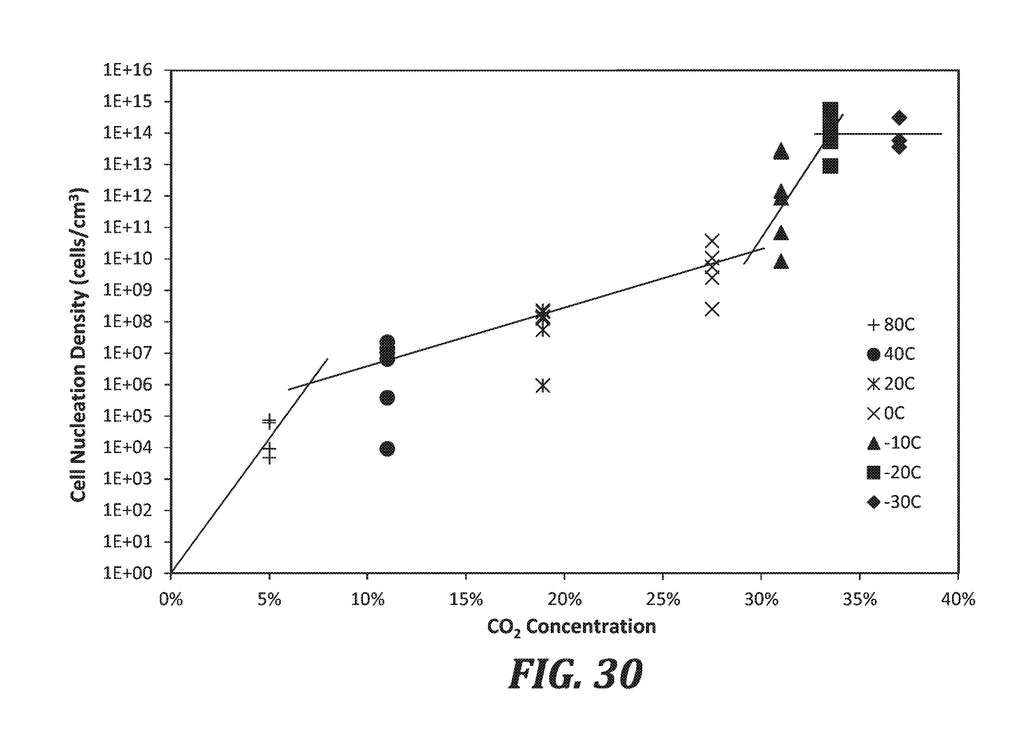

To better visualize how cell nucleation densities evolve as CO₂ concentration increases, the cell nucleation densities at various saturation temperatures as a function of CO₂ concentration is plotted in FIG. 30. At each saturation temperature, data from different foaming temperatures are plotted together.

At 5% CO₂ concentration, the cell size is relatively big (>100 μm) and thus can be considered macrocellular. And at 11%, cell size was below <100 μm and is considered as microcellular. Between 5% and 11%, there is a rate change of cell nucleation density increase. This is the macro-to-micro transition. Following the macro-to-micro transition is a steady increase of cell nucleation density with increasing CO₂ concentration.

However, between 27.5% and 31%, the rate of cell nucleation density increase is enhanced. This rapid increase reduces the cell size from micrometer scale down to nanometer scale, and thus the microcellular foams become nanofoams. This is the micro-to-nano transition.

Above 33.5%, further increase in CO₂ concentration does not result in an increase of cell nucleation density. Instead, a horizontal trend is observed. At 37% CO₂ concentration, the cellular structure turns into the “worm-like” nanostructure, of which cell nucleation densities cannot be calculated.

While illustrative embodiments have been illustrated and described, it will be appreciated that various changes can be made therein without departing from the spirit and scope of the invention.

The embodiments of the invention in which an exclusive property or privilege is claimed are defined as follows:

1. A method of making a thermoplastic polymer foam, comprising:
saturating a noncellular thermoplastic polymer with liquid carbon dioxide to produce a carbon dioxide saturated thermoplastic polymer; and
heating the saturated thermoplastic polymer to create a thermoplastic polymer having a cellular structure with cells having an average cell size of about 100 nm or less.

2. The method of claim 1, wherein the thermoplastic polymer is selected from at least one of polycarbonate (PC), polymethyl methacrylate (PMMA), cyclic olefin copolymer (COC), polysulfone (PSU), polyphenylsulfone (PPSU), polyether ether ketone (PEEK), polylactic acid (PLA), thermoplastic urethane (TPU), low density polyethylene LDPE, high density polyethylene HDPE, ultra high molecular weight polyethylene (UHMWPE), polytetrafluoroethylene (PTFE), polypropylene (PP), polystyrene (PS), acrylonitrile butadiene styrene (ABS), polyethylene terephthalate (PET), and crystalline polyethylene terephthalate (CPET).

3. The method of claim 1, wherein a carbon dioxide concentration for producing an average cell size of 100 nm or less is about 15% by weight or greater, or about 17.4% by weight or greater, and the polymer is polycarbonate.

4. The method of claim 1, wherein a carbon dioxide concentration for producing an average cell size of 100 nm or less is about 27.5% by weight or greater, or about 31% by weight or greater, and the polymer is polymethyl methacrylate.

5. The method of claim 1, wherein a carbon dioxide concentration for producing an average cell size of 100 nm or less is about 10% by weight or greater, or about 15% by weight or greater, and the polymer is polysulfone or polyphenylsulfone.

6. The method of claim 1, wherein a carbon dioxide concentration for producing an average cell size of 100 nm or less is about 5% by weight or greater, or about 8% by weight or greater, and the polymer is cyclic olefin copolymer.

7. The method of claim 1, wherein a carbon dioxide concentration for producing an average cell size of 100 nm or less is about 12% by weight or greater, or about 18.5% by weight or greater, and the polymer is polyethylene terephthalate.

8. The method of claim 1, wherein the cellular structure comprises open interconnected pores.

9. The method of claim 1, wherein the step of saturating is performed at a temperature of 0° C. or less and a pressure of 5 MPa or less.

10. The method of claim 1, wherein the thermoplastic polymer is a homopolymer.

11. The method of claim 1, wherein the thermoplastic polymer is a copolymer.

12. The method of claim 1, wherein the thermoplastic polymer is a blend of two or more polymers.

13. The method of claim 1, wherein the polymer is about 100% by weight thermoplastic polymer.

14. The method of claim 1, wherein the polymer comprises nonpolymer additives.

15. A thermoplastic polymer foam, comprising:
an average cell size of 100 nm or less;
a relative density of 50% or less; and
about 100% by weight of thermoplastic polymer.

16. The thermoplastic polymer foam of claim 15, comprising:
about 100% by weight of a polymer selected from at least polycarbonate, polymethyl methacrylate, polysulfone, polyphenylsulfone, cyclic olefin copolymer, polyethylene terephthalate, or a combination thereof.

17. The thermoplastic polymer foam of claim 15, wherein the cells comprise interconnected open cells.

18. The thermoplastic polymer foam of claim 15, wherein the thermoplastic polymer is a homopolymer.

19. The thermoplastic polymer foam of claim 15, wherein the thermoplastic polymer is a copolymer.

20. The thermoplastic polymer foam of claim 15, wherein the thermoplastic polymer is a blend of two or more polymers.
